(19) United States
(12) Patent Application Publication
(10) Pub. No.: US 2004/0069629 A1
(43) Pub. Date: Apr. 15, 2004

(54) Gas sensing element

(76) Inventors: Akio Tanaka, Gifu-shi (JP); Toru Katafuchi, Kariya-shi (JP); Keigo Mizutani, Okazaki-shi (JP); Daisuke Makino, Ichinomiya-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/651,088

(22) Filed: Aug. 29, 2003

(30) Foreign Application Priority Data
Aug. 29, 2002 (JP) 2002-251336
Sep. 17, 2002 (JP) 2002-270455
Oct. 31, 2002 (JP) 2002-318521
Jul. 16, 2003 (JP) 2003-275589

(51) Int. Cl. G01N 27/26

(52) U.S. Cl. 204/424; 204/426

(57) ABSTRACT

A gas sensing element has a pump cell for pumping oxygen into or from a measuring-object gas chamber and a sensor cell for measuring the concentration of a specific gas contained in a measuring-object gas. The pump cell includes a measured gas side pump electrode exposed to the measuring-object gas stored in the measuring-object gas chamber. An upstream portion of a measured gas side pump electrode, positioned at an upstream side of the sensor cell electrode, satisfies the following relationship

2.0≦c/a≦7.0

where ‘c’ represents a maximum longitudinal length of the upstream portion of the measured gas side pump electrode, and ‘a’ represents a maximum lateral width of the upstream portion of the measured gas side pump electrode.

### BACKGROUND OF THE INVENTION

This invention relates to a gas sensing element installed as part of an exhaust gas purifying system of an internal combustion engine to measure the concentration of NOx, oxygen, or other specific gas contained in the exhaust gas emitted from the engine or to obtain an air-fuel ratio of gas mixture introduced into a combustion chamber.

For example, a gas sensing element includes a pump cell for pumping oxygen into a measuring-object gas chamber and a sensor cell measuring the concentration of NOx introduced into the measuring-object gas chamber.

To measure the NOx concentration, the sensor cell consists of a pair of sensor electrodes provided on a solid electrolytic substrate. One sensor electrode is provided on a surface of the solid electrolytic substrate so as to be exposed to a measuring-object gas (i.e., NOx) stored in the measuring-object gas chamber. The other sensor electrode is provided on another surface of the solid electrolytic substrate so as to be exposed to a reference gas (e.g., air) stored in a reference gas chamber. The sensor electrode exposed to the measuring-object gas possesses active nature against NOx.

Meanwhile, the pump cell consists of a pair of pump electrodes provided on a solid electrolytic substrate. One pump electrode is provided on a surface of the solid electrolytic substrate so as to be exposed to the measuring-object gas stored in the measuring-object gas chamber. The pump electrode exposed to the measuring-object gas possesses inactive nature against NOx.

Measurement of NOx concentration in the sensor cell is performed by decomposing NOx on the sensor electrode exposed to the measuring-object gas. Decomposed NOx generates oxygen ion current based on which the NOx concentration is measured. Accordingly, the oxygen concentration in the measuring-object gas chamber must be either negligible or kept in a stable state.

To this end, the pump cell is used to adjust the oxygen concentration in the measuring-object gas chamber.

However, if the pump cell is insufficient in the capability of pumping oxygen, it will be difficult to stably maintain the oxygen concentration in the measuring-object gas chamber. Furthermore, even if the pumping capability of the pump cell is satisfactory, the sensor cell will not be able to accurately measure the NOx concentration unless adjustment of the oxygen concentration is accomplished before the measuring-object gas reaches the sensor electrode sensor electrode exposed to the measuring-object gas.

The pumping ability of the pump cell is variable depending on whether the pump electrode sufficiently contacts with the measuring-object gas stored in the measuring-object gas chamber. Hence, inappropriate arrangement of the pump electrode will result in insufficient adjustment of the oxygen concentration of the measuring-object gas conveyed to the sensor electrode. As a result, the sensor cell will produce a significant amount of offset current which flows even when no NOx is contained in the measuring-object gas. The NOx concentration by the gas sensing element cannot be accurately performed.

On the other hand, it may be possible to dispose a sufficiently large pump electrode exposed to the measuring-object gas at the upstream side of the sensor electrode. However, in this case, the measuring-object gas introduced into the measuring-object gas chamber is subjected to a long diffusion length. The measuring-object gas requires a significantly long time to reach the sensor electrode. The response of the gas sensing element will be worsened.

### SUMMARY OF THE INVENTION

In view of the above-described problems, the present invention has an object to provide a gas sensing element which has reliable measuring accuracy and excellent response.

In order to accomplish the above and other related objects, the present invention provides a first gas sensing element including a measuring-object gas chamber into which a measuring-object gas to be measured is introduced from the outside, a reference gas chamber into which a reference gas is introduced, a pump cell for pumping oxygen into or from the measuring-object gas chamber, and a sensor cell for measuring a concentration of a specific gas contained in the measuring-object gas. According to the first gas sensing element of the present invention, the pump cell includes a solid electrolytic substrate, a first pump electrode provided on a surface of this solid electrolytic substrate so as to be exposed to the measuring-object gas stored in the measuring-object gas chamber, and a second pump electrode provided on an opposite surface of the solid electrolytic substrate. The sensor cell includes a solid electrolytic substrate, a first sensor electrode provided on a surface of this solid electrolytic substrate so as to be exposed to the measuring-object gas stored in the measuring-object gas chamber, and a second sensor electrode provided on another surface of the solid electrolytic substrate so as to be exposed to the reference gas stored in the reference gas chamber. And, the first pump electrode has an upstream portion positioned at an upstream side of the first sensor electrode in the flow direction of the measuring-object gas, and the upstream portion of the first pump electrode satisfies the following relationship

2.0≦c/a≦7.0

where ‘c’ represents a maximum length of the upstream portion of the first pump electrode in a longitudinal direction of the gas sensing element, and ‘a’ represents a maximum width of the upstream portion of the first pump electrode in a transverse direction of the gas sensing element.

As the ratio ‘c/a’ is not smaller than 2.0, the measuring-object gas introduced into the measuring-object gas chamber can sufficiently contact with the pump electrode in the process of diffusing in the longitudinal direction of the gas sensing element. Accordingly, the pump cell can adequately adjust the oxygen concentration in the measuring-object gas. The sensor cell can accurately measure the concentration of a specific gas contained in the measuring-object gas.

As the ratio ‘c/a’ is not greater than 7.0, the diffusion length of the measuring-object gas introduced in the measuring-object gas chamber becomes small. The measuring-object gas can smoothly reach the sensor electrode without requiring a long time. The first gas sensing element can assure prompt response.

Accordingly, the present invention can provide a gas sensing element possessing reliable measuring accuracy and excellent response.

Furthermore, the present invention has an object to provide a multilayered gas sensing element which is capable of accurately detecting a specific gas concentration without being influenced by oxygen residing in a measuring-object gas chamber.

In order to accomplish the above and other related objects, the present invention provides a first multilayered gas sensing element including a measuring-object gas chamber into which a measuring-object gas is introduced under a predetermined diffusion resistance. An oxygen pump cell having a pair of pump electrodes is provided on surfaces of an oxygen ion conductive solid electrolytic substrate, with one of the pump electrodes being positioned in the measuring-object gas chamber, for pumping oxygen into or from the measuring-object gas chamber in response to electric power supplied to the pump electrodes to adjust an oxygen concentration in the measuring-object gas chamber. And, a sensor cell having a pair of sensor electrodes is provided on surfaces of an oxygen ion conductive solid electrolytic substrate, with one of the sensor electrodes being positioned in the measuring-object gas chamber, for detecting a specific gas concentration in the measuring-object gas chamber based on an oxygen ion current produced between the sensor electrodes. According to the first multilayered gas sensing element of the present invention, the pump electrode positioned in the measuring-object gas chamber has a side surface extending in a longitudinal direction of the gas sensing element and facing via a clearance region to an inside surface of the measuring-object gas chamber, and a minimum value of a total width G of the clearance region in a transverse direction of the gas sensing element is not greater than 0.5 mm.

Furthermore, the present invention provides a second multilayered gas sensing element including a measuring-object gas chamber into which a measuring-object gas is introduced under a predetermined diffusion resistance. An oxygen pump cell having a pair of pump electrodes is provided on surfaces of an oxygen ion conductive solid electrolytic substrate, with one of the pump electrodes being positioned in the measuring-object gas chamber, for pumping oxygen into or from the measuring-object gas chamber in response to electric power supplied to the pump electrodes to adjust an oxygen concentration in the measuring-object gas chamber. And, a sensor cell having a pair of sensor electrodes is provided on surfaces of an oxygen ion conductive solid electrolytic substrate, with one of the sensor electrodes being positioned in the measuring-object gas chamber, for detecting a specific gas concentration in the measuring-object gas chamber based on an oxygen ion current produced between the sensor electrodes. According to the second multilayered gas sensing element of the present invention, the pump electrode positioned in the measuring-object gas chamber has a downstream portion positioned at a downstream side of a measuring-object gas introducing hole in a flow direction of the measuring-object gas, and the downstream portion of the pump electrode satisfies the following relationship

Sg/Se≦0.3

where Se represents an area of the downstream portion of the pump electrode, and Sg represents the total area of a clearance region residing between a side surface of the downstream portion of the pump electrode extending in a longitudinal direction of the gas sensing element and an inside surface of the measuring-object gas chamber.

The measuring-object gas flowing in the vicinity of the surface of the pump electrode in the measuring-object gas chamber is likely to be subjected to oxygen ionization by the pump electrode. In this case, generated oxygen ions flow as an oxygen ion current between the pump electrodes and are easily taken out of the measuring-object gas chamber.

However, some of the measuring-object gas forms a side stream flowing along a clearance region between a longitudinal side surface of the pump electrode and the inside surface of the measuring-object gas chamber. Due to distance from the pump electrode, the oxygen contained in this side stream is not ionized by the pump electrode.

The specific gas is discomposed on the sensor electrode positioned in the measuring-object gas chamber. Generated oxygen ions flow as an oxygen ion current between the sensor electrodes. The sensor cell detects the concentration of the specific gas based on this oxygen ion current.

In this manner, the measuring-object gas chamber includes oxygen ions originated from the oxygen and oxygen ions originated from the specific gas. Thus, it becomes difficult to accurately detect the concentration of the specific gas concentration.

According to the first multilayered gas sensing element of the present invention, the clearance region between the side surface of the pump electrode and the inside surface of the measuring-object gas chamber is sufficiently small. According to the second multilayered gas sensing element of the present invention, the clearance region has a sufficiently small area compared with that of the pump electrode. Thus, almost all of the measuring-object gas can pass on the pump electrode of the oxygen pump cell.

Therefore, it becomes possible to sufficiently reduce the oxygen concentration in the measuring-object gas chamber and it becomes possible to enable highly-accurate specific gas concentration measurement not being adversely influenced by the oxygen.

Accordingly, the present invention can provide a multilayered gas sensing element which is capable of accurately detecting the specific gas concentration without being influenced by oxygen residing in the measuring-object gas chamber.

Furthermore, the present invention provides a second gas sensing element including a plurality of electrochemical cells, each including a solid electrolytic substrate and a pair of electrodes provided on the solid electrolytic substrate. A measuring-object gas is introduced into a measuring-object gas chamber. A spacer, laminated on the solid electrolytic substrate, defines the measuring-object gas chamber. A gas introducing passage introduces the measuring-object gas into the measuring-object gas chamber from an outside. At least one of the plurality of electrochemical cells is a pump cell for pumping oxygen from the measuring-object gas chamber to adjust an oxygen concentration in the measuring-object gas chamber. At least one of the plurality of electrochemical cells is a sensor cell for decomposing a specific gas in the measuring-object gas chamber to measure a specific gas concentration in the measuring-object gas chamber based on oxygen ions resulting from decomposed specific gas. The measuring gas chamber includes a plurality of cell chambers in which the electrochemical cells are provided, and a rate-determining diffusion passage connecting the cell chambers and allowing the measuring-object gas to flow between the cell chambers with a reduced flow rate. According to the second gas sensing element, the gas introducing passage and the rate-determining diffusion passage satisfy the following relationship

(Sn/Ln)/(S0/L0)≦0.4

where L0 represents a longitudinal length of the gas introducing passage, S0 represents a transverse cross-sectional area of the gas introducing passage, Ln represents a longitudinal length of the rate-determining diffusion passage, and Sn represents a transverse cross-sectional area of the rate-determining diffusion passage.

In a gas sensor, the measuring-object gas enters into the measuring-object gas chamber via the measuring-object gas introducing passage. In the pump cell chamber of the measuring-object gas chamber in which the pump cell is provided, the oxygen concentration in the measuring-object gas is maintained stably at a lower value by the pumping function of the pump cell. If the measuring-object gas moves into the sensor cell chamber of the measuring-object gas chamber before the pumping is not completely performed, the oxygen concentration will become higher or fluctuate in the sensor cell chamber. Furthermore, there is the possibility that the pumping performance temporarily may deteriorate depending on circumferential conditions. In this case, the oxygen concentration will become higher or fluctuate in the sensor cell chamber.

Accordingly, diffusion of the measuring-object gas flowing into the sensor cell chamber from the pump cell chamber is controlled to an appropriate rate, so that oxygen can be sufficiently discharged from the pump chamber before the oxygen enters into the sensor cell chamber. Thus, the oxygen concentration in the sensor cell chamber can be kept stably at a lower value. Fluctuation of the oxygen concentration can be eliminated. In other words, fluctuation of the sensor cell output can be reduced.

In general, a significant amount of current flowing in the sensor cell even when no specific gas is contained in the measuring-object gas is referred to as offset current. The second gas sensing element has the arrangement capable of restricting the diffusion of oxygen flowing into the sensor cell chamber. Thus, the second gas sensing element can reduce the amount of offset current and suppress the fluctuation of offset current.

If (Sn/Ln)/(S0/L0) is greater than 0.4, the offset current will become large and accordingly the detection accuracy of the specific gas concentration will be worsened.

When the gas sensing element is installed in an exhaust gas passage of an automotive engine, the oxygen concentration in the exhaust gas and the temperature of the exhaust gas frequently change depending on variations of engine operating conditions. Due to these changes, the pumping ability of the pump cell is not stable. In this case, the offset current will change in accordance with the pumping ability of the pump cell. The second gas sensing element of the present invention is small and stable in the offset current. Thus, it becomes possible to accurately detect the specific gas concentration even in the environments where the pumping ability of the pump cell tends to change frequently.

Furthermore, the present invention provides a third gas sensing element including a plurality of electrochemical cells, each including a solid electrolytic substrate and a pair of electrodes provided on the solid electrolytic substrate. A measuring-object gas is introduced into measuring-object gas chamber. A spacer, laminated on the solid electrolytic substrate, defines the measuring-object gas chamber. A gas introducing passage introduces the measuring-object gas into the measuring-object gas chamber from an outside. At least one of the plurality of electrochemical cells is a pump cell for pumping oxygen from the measuring-object gas chamber to adjust an oxygen concentration in the measuring-object gas chamber. At least one of the plurality of electrochemical cells is a sensor cell for decomposing a specific gas in the measuring-object gas chamber to measure a specific gas concentration in the measuring-object gas chamber based on oxygen ions resulting from decomposed specific gas. The measuring gas chamber includes a plurality of cell chambers in which the electrochemical cells are provided, and a rate-determining diffusion passage connecting the cell chambers and allowing the measuring-object gas to flow between the cell chambers with a reduced flow rate. According to the third gas sensing element, the pump cell and the sensor cell satisfy the following relationship when the oxygen concentration is 20%,

Is/Ip≦0.3

where Ip represents a pump limit current value flowing between the electrodes of the pump cell, and Is represents a sensor limit current value flowing between the electrodes of the sensor cell under a condition that the pump cell is not operating.

The gas sensing element possesses current-voltage characteristics showing a constant current region where the pump current does not change regardless of variation of the voltage applied to the pump cell. The pump current value in this voltage region is generally referred to as pump limit current. When the pumping ability of the pump cell is large, the pump limit current value becomes large even if the oxygen concentration in the measuring-object gas is constant. The sensor current flowing in the sensor cell, when the pump cell is not operating, varies depending on the oxygen contained in the measuring-object gas and also depending on oxygen ions resultant from the specific gas contained in the measuring-object gas. If the diffusion of the measuring-object gas to the sensor cell is restricted, the sensor limit current value Is will become small.

According to the third gas sensing element characterized by Is/Ip≦0.3, the pumping ability of the pump cell can be kept highly and the gas diffusion from the pump cell to the sensor cell can be restricted appropriately. Thus, the oxygen concentration in the vicinity of the sensor cell is small and stable. The third gas sensing element brings the effect of improving measuring accuracy of the specific gas.

If Is/Ip is greater than 03, the offset current will become so large that it cannot be negligible compared with the sensor current resulting from the specific gas. The measuring accuracy of the specific gas will be worsened.

Furthermore, the present invention provides a fourth gas sensing element including a plurality of electrochemical cells, each including a solid electrolytic substrate and a pair of electrodes provided on the solid electrolytic substrate. A measuring-object gas is introduced into measuring-object gas chamber. A spacer, laminated on the solid electrolytic substrate, defines the measuring-object gas chamber. A gas introducing passage introduces the measuring-object gas into the measuring-object gas chamber from an outside. At least one of the plurality of electrochemical cells is a pump cell for pumping oxygen from the measuring-object gas chamber to adjust an oxygen concentration in the measuring-object gas chamber. At least one of the plurality of electrochemical cells is a sensor cell for decomposing a specific gas in the measuring-object gas chamber to measure a specific gas concentration in the measuring-object gas chamber based on oxygen ions resulting from decomposed specific gas. The measuring gas chamber includes a plurality of cell chambers in which the electrochemical cells are provided, and a rate-determining diffusion passage connecting the cell chambers and allowing the measuring-object gas to flow between the cell chambers with a reduced flow rate. According to the four gas sensing element, the pump cell and the sensor cell satisfy the following relationship when the oxygen concentration is 20%,

Is/Sp≦0.06 mA/mm²

where Is represents a sensor limit current value flowing between the electrodes of the sensor cell under a condition that the pump cell is not operating, and Sp represents an area of the pump cell electrode positioned in the measuring-object gas chamber.

When the electrode area of the pump cell is large, the oxygen pumping ability of the pump cell is high. When the relationship Is/Sp≦0.06 mA/mm² is satisfied, the oxygen pumping ability of the pump cell increases compared with the gas amount diffusing from the pump cell chamber to the sensor cell chamber. Thus, the oxygen concentration in the vicinity of the sensor cell becomes low and stale. As a result, it becomes possible to reduce the offset current flowing in the sensor cell when the specific gas concentration is zero.

If Is/Sp is greater than 0.06 mA/mm², the offset current will become so large that it cannot be negligible compared with the sensor current resulting from the specific gas. The measuring accuracy of the specific gas will be worsened. It is preferable that the relationship Is/Ip≦0.05 mA/mm² is satisfied.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a longitudinal vertical cross-sectional view showing the arrangement of a gas sensing element in accordance with a first embodiment of the present invention;

FIG. 2 is a perspective development view showing the gas sensing element in accordance with the first embodiment of the present invention shown in FIG. 1;

FIG. 3 is a transverse cross-sectional view showing the arrangement of the gas sensing element in accordance with the first embodiment of the present invention, taken along a line 1A-1A shown in FIG. 1;

FIG. 4 is a view explaining positional relationship between a main pump cell and a monitor pump cell in accordance with the first embodiment of the present invention shown in FIG. 1;

FIG. 5 is a graph showing test data representing the relationship between offset current and response time obtained from test samples of the gas sensing elements;

FIG. 6 is a graph showing test data representing the relationship between offset current and electrode resistance obtained from test samples of the gas sensing elements;

FIG. 7 is a graph showing voltage-current relationship and electrode resistance;

FIG. 8 is a longitudinal vertical cross-sectional view showing the arrangement of a gas sensing element in accordance with a second embodiment of the present invention, according to which two measuring-object gas chambers are offset from each other in the vertical direction normal to surfaces of multilayered substrates;

FIG. 9 is a longitudinal vertical cross-sectional view showing the arrangement of a modified gas sensing element in accordance with the second embodiment of the present invention, which is similar to but arranged differently from that shown in FIG. 8;

FIG. 10 is a longitudinal vertical cross-sectional view showing the arrangement of a gas sensing element in accordance with a third embodiment of the present invention, according to which a monitor pump cell and a sensor cell are serially arranged;

FIG. 11 is a plan view explaining positional relationship between a main pump cell, a monitor pump cell, and a sensor cell in accordance with the embodiment of the present invention shown in FIG. 10;

FIG. 12 is a longitudinal vertical cross-sectional view showing the arrangement of a gas sensing element in accordance with a fourth embodiment of the present invention, which includes only a sensor cell and a pump cell;

FIG. 13 is a longitudinal vertical cross-sectional view showing the arrangement of a gas sensing element in accordance with a fifth embodiment of the present invention, according to which a measured gas side electrode of a main monitor pump cell is formed on each of upper, lower, right and left walls of a measuring-object gas chamber;

FIG. 14 is a transverse cross-sectional view showing the arrangement of the gas sensing element in accordance with the fifth embodiment of the present invention, taken along a line 1B-1B shown in FIG. 13;

FIG. 15A is a longitudinal vertical cross-sectional view showing the arrangement of a gas sensing element in accordance with a sixth embodiment of the present invention;

FIG. 15B is a transverse cross-sectional view showing the gas sensing element in accordance with the sixth embodiment, taken along a line 2A-2A shown in FIG. 15A;

FIG. 16 is a perspective development view showing the gas sensing element in accordance with the sixth embodiment of the present invention;

FIG. 17 is a horizontal cross-sectional view showing the gas sensing element in accordance with the sixth embodiment, taken along a line 2B-2B shown in FIG. 15A;

FIG. 18 is a schematic view explaining the width of a pump electrode and the width of a clearance region interposed between the pump electrode and a measuring-object gas chamber;

FIG. 19 is a horizontal cross-sectional view showing another pump electrode in accordance with the sixth embodiment of the present invention;

FIG. 20 is a horizontal cross-sectional view showing a relationship between a pinhole and a pump electrode in accordance with the sixth embodiment of the present invention;

FIG. 21 is a schematic view explaining the area of a pump electrode and the area of a clearance region interposed between the pump electrode and a measuring-object gas chamber;

FIG. 22 is a graph showing test data representing the relationship between detection error and total width G of the clearance region obtained from test samples of the gas sensing elements;

FIG. 23 is a graph showing test data representing the relationship between detection error and L/Le obtained from test samples of the gas sensing elements;

FIG. 24 is a graph showing test data representing the relationship between detection error and Sg/Se obtained from test samples of the gas sensing elements;

FIG. 25 is a horizontal cross-sectional view showing the arrangement of a modified gas sensing element in accordance with the sixth embodiment of the present invention;

FIG. 26 is a horizontal cross-sectional view showing the arrangement of another modified gas sensing element in accordance with the sixth embodiment of the present invention;

FIG. 27 is a horizontal cross-sectional view showing the arrangement of a modified gas sensing element in accordance with the sixth embodiment of the present invention;

FIG. 28A is a longitudinal vertical cross-sectional view showing the arrangement of a gas sensing element in accordance with a seventh embodiment of the present invention;

FIG. 28B is a transverse cross-sectional view showing the gas sensing element in accordance with the seventh embodiment, taken along a line 2C-2C shown in FIG. 28A;

FIG. 29 is a longitudinal vertical cross-sectional view showing the arrangement of a gas sensing element in accordance with an eighth embodiment of the present invention;

FIG. 30 is a longitudinal vertical cross-sectional view showing the arrangement of a gas sensing element in accordance with a ninth embodiment of the present invention;

FIG. 31 is a transverse cross-sectional view showing the arrangement of the gas sensing element in accordance with the ninth embodiment of the present invention, taken along a line 3A-3A shown in FIG. 30;

FIG. 32A is a longitudinal vertical cross-sectional view showing the arrangement of the gas sensing element in accordance with the ninth embodiment of the present invention;

FIG. 32B is a horizontal cross-sectional view showing the arrangement of the gas sensing element in accordance with the ninth embodiment of the present invention;

FIG. 33 is a graph showing offset current and response in relation to (Sn/Ln)/(S0/L0) obtained from test samples of the gas sensing elements;

FIG. 34 is a graph showing test data representing the relationship between accuracy and (Sn/Ln)/(S0/L0) obtained from test samples of the gas sensing elements;

FIG. 35A is a longitudinal vertical cross-sectional view showing the arrangement of another gas sensing element in accordance with the ninth embodiment of the present invention;

FIG. 35B is a horizontal cross-sectional view showing the arrangement of the gas sensing element shown in FIG. 35A;

FIG. 36 is a horizontal cross-sectional view showing the arrangement of another gas sensing element in accordance with the ninth embodiment of the present invention;

FIG. 37A is a horizontal cross-sectional view showing the arrangement of another gas sensing element in accordance with the ninth embodiment of the present invention;

FIG. 37B is a longitudinal vertical cross-sectional view showing the arrangement of another gas sensing element shown in FIG. 37A;

FIG. 38 is a longitudinal vertical cross-sectional view showing the arrangement of a gas sensing element in accordance with a tenth embodiment of the present invention;

FIG. 39 is a horizontal cross-sectional view showing the arrangement of the gas sensing element in accordance with the tenth embodiment of the present invention;

FIG. 40 is a horizontal cross-sectional view showing a first pump electrode of the gas sensing element in accordance with the tenth embodiment of the present invention;

FIG. 41 is a horizontal cross-sectional view showing a second pump electrode of the gas sensing element in accordance with the tenth embodiment of the present invention;

FIG. 42 is a graph showing offset current and response in relation to Is/Ip obtained from test samples of the gas sensing elements;

FIG. 43 is a longitudinal vertical cross-sectional view showing the arrangement of another gas sensing element in accordance with the tenth embodiment of the present invention;

FIG. 44 is a horizontal cross-sectional view showing the arrangement of the gas sensing element shown in FIG. 44;

FIG. 45 is a graph showing offset current and response in relation to a transverse width Wn of the rate-determining diffusion passage obtained from test samples of the gas sensing elements;

FIG. 46 is a graph showing offset current and response in relation to a longitudinal length Ln of the rate-determining diffusion passage obtained from test samples of the gas sensing elements; and

FIG. 47 is a graph showing offset current and response in relation to a vertical thickness t of the rate-determining diffusion passage obtained from test samples of the gas sensing elements.

### DESCRIPTION OF THE PREFERRED EMBODIMENTS

According to the present invention, a gas sensing element includes a measuring-object gas chamber into which a measuring-object gas to be measured is introduced from the outside and a reference gas chamber into which a reference gas is introduced. A pump cell is provided for pumping oxygen into or from the measuring-object gas chamber. A sensor cell is provided for measuring the concentration of a specific gas contained in the measuring-object gas.

The pump cell includes a first pump electrode provided on a surface of a solid electrolytic substrate so as to be exposed to the measuring-object gas stored in the measuring-object gas chamber, and a second pump electrode provided on an opposite surface of the solid electrolytic substrate.

The sensor cell includes a first sensor electrode provided on a surface of a solid electrolytic substrate so as to be exposed to the measuring-object gas stored in the measuring-object gas chamber, and a second sensor electrode provided on another surface of the second solid electrolytic substrate so as to be exposed to the reference gas stored in the reference gas chamber.

The first pump electrode has an upstream portion positioned at an upstream side of the first sensor electrode in the flow direction of the measuring-object gas, and the upstream portion of the first pump electrode satisfies the following relationship

2.0≦c/a≦7.0

where ‘c’ represents a maximum length of the upstream portion of the first pump electrode in the longitudinal direction of the gas sensing element, and ‘a’ represents a maximum width of the upstream portion of the first pump electrode in the transverse direction of the gas sensing element.

In this invention, the specific gas is, for example, NOx, CO, HC, or the like.

The pump cell of the present invention includes not only a main pump cell for pumping oxygen into or from the measuring-object gas chamber but also any other cell having the pumping capability. For example, a monitor pump cell for monitoring the oxygen concentration in the measuring-object gas is regarded as one of the pump cells according to the present invention.

Preferably, the pump cell and the sensor cell further satisfy the following relationship

2≦Sp/Ss≦30

where ‘Sp’ represents an area of the upstream portion of the first pump electrode positioned at the upstream side of the first sensor electrode while ‘Ss’ represents an area of the first sensor electrode of the sensor cell.

In this case, it becomes possible to provide a gas sensing element having higher measuring accuracy without lowering activity of the sensor electrode exposed to the measuring-object gas.

When Sp/Ss is lower than 2, the pump cell cannot sufficiently perform pumping of oxygen. Accurate measurement of the specific gas concentration is unfeasible. On the other hand, when Sp/Ss is greater than 30, the inactive components added to the pump electrode as possessing inactive nature against the specific gas may scatter and adhere on the sensor electrode in the sintering process for integrally manufacturing the gas sensing element. Accordingly, the activity of the sensor electrode exposed to the measuring-object gas will deteriorate. Accurate measurement is unfeasible.

Preferably, the pump electrode exposed to the measuring-object gas contains Pt—Au.

This assures not only excellent heat resistance but also excellent inactiveness against NOx or comparable specific gas for the pump electrode exposed to the measuring-object gas. Thus, no decomposition of NOx or comparable specific gas occurs on the pump electrode. No adverse influence is given to the measuring accuracy of the sensor cell.

Preferably, Au content in the Pt—Au is in a range from 1 wt % to 5 wt %.

This effectively suppresses decomposition of NOx or comparable specific gas at the pump electrode. Meanwhile, oxygen decomposing property of the pump electrode is assured.

If the Au content is less than 1 wt %, NOx or comparable specific gas will be partly decomposed at the pump electrode. On the other hand, if the Au content is greater than 5 wt %, oxygen decomposing property of the pump electrode will be worsened.

First Embodiment

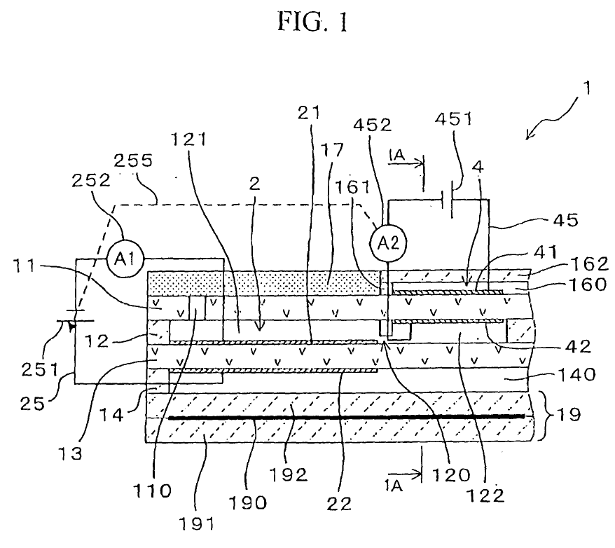

A gas sensing element in accordance with a preferred embodiment will be explained with reference to FIGS. 1 to 4.

A gas sensing element 1 includes measuring-object gas chambers 121 and 122 into which a measuring-object gas to be measured is introduced from the outside. Two measuring-object gas chambers 121 and 122 are connected to each other. A reference gas, e.g., air, is introduced into a reference gas chamber 160. A main mump cell 2 and a monitor pump cell 3 are provided for pumping oxygen into or from the measuring-object gas chambers 121 and 122. A sensor cell 4 is provided for measuring the concentration of a specific gas contained in the measuring-object gas.

The main pump cell 2 is composed of a second solid electrolytic substrate 13, a first pump electrode 21 provided on a surface of the second solid electrolytic substrate 13 so as to be exposed to the measuring-object gas stored in the measuring-object gas chamber 121, and a second pump electrode 22 provided on an opposite surface of the second solid electrolytic substrate 13. In the following description, the first pump electrode 21 is referred to as ‘measured gas side pump electrode.’ The second pump electrode 22 is referred to as ‘air side pump electrode’.

The monitor pump cell 3 is composed of a first solid electrolytic substrate 11, a first monitor electrode 32 provided on a surface of the first solid electrolytic substrate 11 so as to be exposed to the measuring-object gas stored in the measuring-object gas chamber 122, and a second monitor electrode 31 provided on an opposite surface of the first solid electrolytic substrate 11. In the following description, the first monitor electrode 32 is referred to as ‘measured gas side monitor electrode’. The second monitor electrode 31 is referred to as ‘air side monitor electrode’.

The sensor cell 4 is composed of the first solid electrolytic substrate 11, a first sensor electrode 42 provided on a surface of the first solid electrolytic substrate 11 so as to be exposed to the measuring-object gas stored in the measuring-object gas chamber 122, and a second sensor electrode 41 provided on another surface of the first solid electrolytic substrate 11 so as to be exposed to the reference gas stored in the reference gas chamber 160.

In the following description, the first sensor electrode 42 is referred to as ‘measured gas side sensor electrode’. The second sensor electrode 41 is referred to as ‘reference sensor electrode’.

The pump electrode exposed to the measuring-object gas, i.e., the measured gas side pump electrode 21 of the main pump cell 2 and the measured gas side monitor electrode 32 of the monitor pump cell 3, has an upstream portion positioned at an upstream side of the measured gas side sensor electrode 42 in the flow direction of the measuring-object gas.

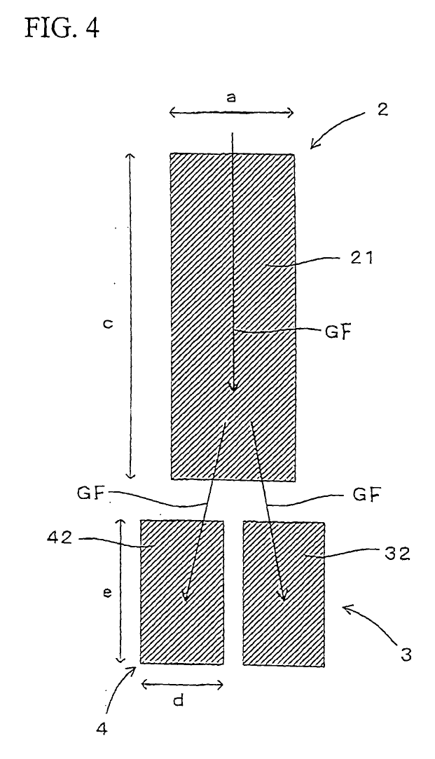

As shown in FIG. 4, the upstream portion of the pump electrode exposed to the measuring-object gas satisfies the following relationship

2.0≦c/a≦7.0

where ‘c’ represents a maximum length of the above-described upstream portion of the pump electrode in a longitudinal direction of the gas sensing element, and ‘a’ represents a maximum width of the upstream portion of the pump electrode in a transverse direction of the gas sensing element.

According to this embodiment, as shown in FIG. 4, only the entire region of the measured gas side pump electrode 21 is the upstream portion of the pump electrode exposed to the measuring-object gas positioned at the upstream side of the measured gas side sensor electrode 42 in the flow direction (indicated by an arrow GF) of the measuring-object gas. Accordingly, ‘c’ represents the longitudinal length of the measured gas side pump electrode 21 and ‘a’ represents the lateral width of the measured gas side pump electrode 21. Thus, the dimensions of the measured gas side pump electrode 21 satisfy the given condition 2.0≦c/a≦7.0.

Furthermore, the following relationship is satisfied.

2≦Sp/Ss≦30

where ‘Sp’ represents an area of the upstream portion of the measured gas side pump electrode 21 of the main pump cell 2 while ‘Ss’ represents an area of the measured gas side sensor electrode 42 of the sensor cell 4.

The gas sensing element 1 detects the concentration of NOx as the specific gas contained in the exhaust gas emitted from an internal combustion engine. The measured gas side pump electrode 21 and the measured gas side monitor electrode 32 contain Pt—Au. Furthermore, Au content in the Pt—Au, i.e., Au content in a Pt—Au alloy contained in the measured gas side pump electrode 21 and the measured gas side monitor electrode 32, is in the range from 1 wt % to 5 wt %.

More specifically, as shown in FIGS. 1 to 3, the gas sensing element 1 of this embodiment has a multilayered structure composed of the first solid electrolytic substrate 11, a spacer 12 defining the measuring-object chamber, the second solid electrolytic substrate 13, a spacer 14 defining an air chamber, and a ceramic heater 19 stacked or laminated in this order. The gas sensing element 1 has the first measuring-object gas chamber 121, the second measuring-object gas chamber 122, an air chamber 140, and the reference gas chamber 160. The main pump cell 2 performs pumping of oxygen into or from the first measuring-object gas chamber 121. The monitor pump cell 3 monitors the oxygen concentration in the second measuring-object gas chamber 122. The sensor cell 4 detects the NOx concentration in the second measuring-object gas chamber 122.

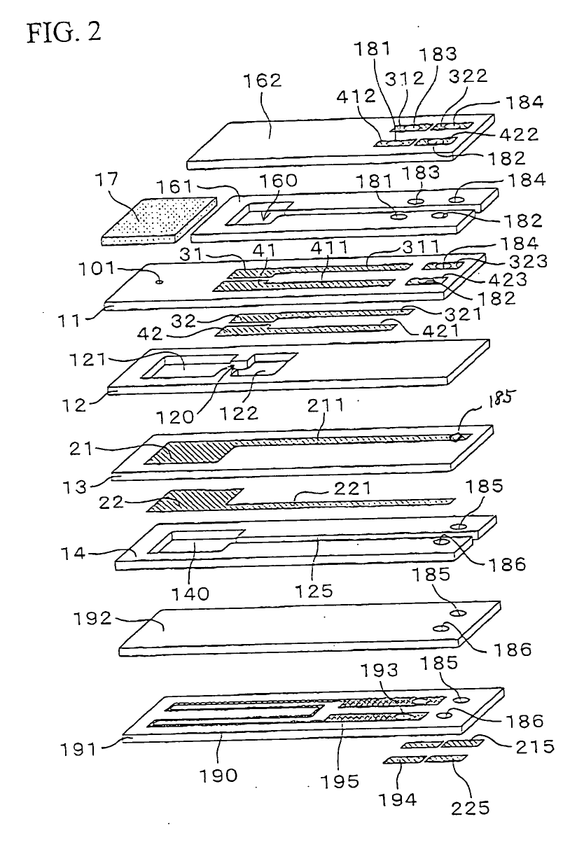

The first measuring-object gas chamber 121 and the second measuring-object gas chamber 122 are defined in the spacer 12 interposed between the first solid electrolytic substrate 11 and the second solid electrolytic substrate 13. As shown in FIGS. 1 and 2, the first measuring-object gas chamber 121 is connected to the outside via an through-hole 110 provided in the first solid electrolytic substrate 11. A diffusion passage 120 connects the first measuring-object gas chamber 121 and the second measuring-object gas chamber 122 so as to communicate with each other. Furthermore, the gas sensing element 1 has a porous diffusion layer 17 covering the through-hole 110 of the first solid electrolytic substrate 11. A two-layered arrangement consisting of a spacer 161 and an insulating plate 162 is provided next to the porous diffusion layer 17.

The first air chamber 140, into which air serving as reference gas is introduced, is defined in the spacer 14 interposed between the second solid electrolytic substrate 13 and the ceramic heater 19. The ceramic heater 19 is composed of a heater substrate 191, a heat generating element 190 provided on the heater substrate 191, and a cover plate 192 covering the heat generating element 190. Each of the first solid electrolytic substrate 11 and the second solid electrolytic substrate 13 are made of zirconia ceramic, while others are made of alumina ceramic. As understood from FIG. 2, electric power is supplied to the heat generating element 190 via a lead portion 195, a through hole 193, and a terminal portion 194.

The main pump cell 2, as shown in FIGS. 1 and 2, includes the measured gas side pump electrode 21 provided on an upper surface of the second solid electrolytic substrate 13 so as to be positioned in the first measuring-object gas chamber 121, and the air side pump electrode 22 provided on a lower surface of the second solid electrolytic substrate 13 so as to be positioned in the first air chamber 140. Both of the measured gas side pump electrode 21 and the air side pump electrode 22 are connected to an electric power source 251 and an ammeter 252 so as to constitute a pump circuit 25.

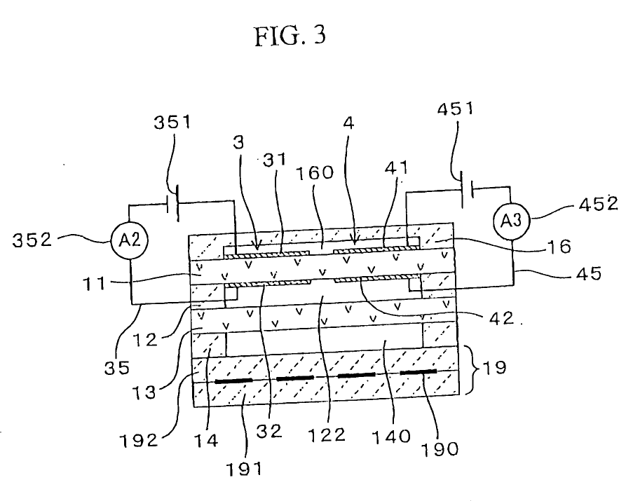

The monitor pump cell 3, as shown in FIGS. 2 and 3, includes the measured gas side monitor electrode 32 provided on a lower surface of the first solid electrolytic substrate 11 so as to be positioned in the second measuring-object gas chamber 122, and the air side monitor electrode 31 provided on an upper surface of the first solid electrolytic substrate 11 so as to be positioned in the second air chamber 160. Both of the measured gas side monitor electrode 32 and the air side monitor electrode 31 are connected to an electric power source 351 and an ammeter 352 so as to constitute a monitor circuit 35.

The sensor cell 4, as shown in FIGS. 1 to 3, includes the measured gas side sensor electrode 42 provided on the lower surface of the first solid electrolytic substrate 11 so as to be positioned in the second measuring-object gas chamber 122, and the reference sensor electrode 41 provided on the upper surface of the first solid electrolytic substrate 11 so as to be positioned in the second air chamber 160. Both of the measured gas side sensor electrode 42 and the reference sensor electrode 41 are connected to an electric power source 451 and an ammeter 452 so as to constitute a sensor circuit 45.

Although not shown in the drawings, a feedback circuit is provided for controlling the electric power source 251 of the main pump cell 2 based on the current value measured by the ammeter 352, thereby controlling the operation of the main pump cell 2 based on the signal of the monitor pump cell 3.

Each of the measured gas side pump electrode 21 and the measured gas side monitor electrode 32 is made of a Pt—Au alloy possessing inactive nature against NOx. The Au content in the Pt—Au alloy is 3 wt %. The measured gas side sensor electrode 42 of the sensor cell 4 is made of a Pt—Rh alloy possessing active nature against NOx. Each of other electrodes 22, 31, and 41 is made of a Pt—Rh alloy. The Rh content in the Pt—Rh alloy is 20 wt %. Furthermore, the measured gas side sensor electrode 42 contains Au added by the amount of 0.2 wt %.

Furthermore, as shown in FIG. 2, the sensor electrodes 41 and 42 of the sensor cell 4 are electrically connected to external terminals 412 and 422 via lead portions 411 and 421, respectively. A through hole 181 is provided vertically across the spacer 161 and the insulating plate 162 from the first solid electrolytic substrate 11. A through hole 182 is provided vertically across the first solid electrolytic substrate 11, the spacer 161, and the insulating plate 162. The lead portions 411 and 421 connect the sensor electrodes 41 and 42 to the external terminals 412 and 422 via the through holes 181 and 182, respectively.

Similarly, as shown in FIG. 2, the monitor electrodes 31 and 32 of the monitor pump cell 3 are electrically connected to external terminals 312 and 322 via lead portions 311 and 321, respectively. A through hole 183 is provided vertically across the spacer 161 and the insulating plate 162 from the first solid electrolytic substrate 11. A through hole 184 is provided vertically across the first solid electrolytic substrate 11, the spacer 161, and the insulating plate 162. The lead portions 311 and 321 connect the monitor electrodes 31 and 32 to the external terminals 312 and 322 via the through holes 183 and 184, respectively.

Similarly, the pump electrodes 21 and 22 of the main pump cell 2 are electrically connected to external terminals 215 and 225 via lead portions 211 and 221, respectively. A through hole 185 is provided vertically across the second solid electrolytic substrate 13, the spacer 14, the heater substrate 191, and the cover plate 192. A through hole 186 is provided vertically across the spacer 14, the heater substrate 191, and the cover plate 192 from the second solid electrolytic substrate 13. The lead portions 211 and 221 connect the pump electrodes 21 and 22 to the external terminals 215 and 225 via the through holes 185 and 186, respectively.

As shown in FIG. 4, the monitor pump cell 3 and the sensor cell 4 are disposed in parallel to each other at the downstream side of the main pump cell 2 in the flow direction of the measuring-object gas. The measured gas side pump electrode 21 of the main pump cell 2 has a longitudinal length of 8.0 mm (c=8.0 mm) and a lateral width of 1.6 mm (a=1.6 mm). Each of the measured gas side monitor electrode 32 and the measured gas side sensor electrode 42 has a longitudinal length of 2.8 mm (e=2.8) and a lateral width of 1.2 mm (d=1.2 mm).

The gas sensing element 1 of this embodiment functions in the following manner.

As described above, the pump electrode exposed to the measuring-object gas (i.e., the measured gas side pump electrode 21 and the measured gas side monitor electrode 32) has the upstream portion positioned at the upstream side of the measured gas side sensor electrode 42 in the flow direction of the measuring-object gas. The upstream portion of the pump electrode exposed to the measuring-object gas satisfies the relationship 2.0≦c/a≦7.0, where ‘c’ represents the maximum length of the above-described upstream portion of the pump electrode in the longitudinal direction of the gas sensing element, and ‘a’ represents the maximum width of the upstream portion of the pump electrode in the transverse direction of the gas sensing element.

Namely, according to the above-described embodiment, as shown in FIG. 4, only the measured gas side pump electrode 21 of the main pump cell 2 corresponds to the upstream portion of the pump electrode and the dimensions of the measured gas side pump electrode 21 satisfy the given condition 2.0≦c/a≦7.0, in which ‘c’ is the longitudinal length of the measured gas side pump electrode 21 and ‘a’ is the lateral width of the measured gas side pump electrode 21.

As the ratio ‘c/a’ is not smaller than 2.0, the measuring-object gas introduced into the first measuring-object gas chamber 121 can sufficiently contact with the measured gas side pump electrode 21 in the process of diffusing in the longitudinal direction of the gas sensing element 1. Accordingly, the pump cell 2 can adequately adjust the oxygen concentration in the measuring-object gas. The sensor cell 4 can accurately measure the concentration of NOx contained in the measuring-object gas.

As the ratio ‘c/a’ is not greater than 7.0, the diffusion length of the measuring-object gas introduced in the measuring-object gas chambers 121 and 122 becomes small. The measuring-object gas can smoothly reach the measured gas side sensor electrode 42 without requiring a long time. The gas sensing element 1 can assure prompt response.

Furthermore, each of the measured gas side pump electrode 21 of the main pump cell 2 and the measured gas side monitor electrode 32 of the monitor pump cell 3 contains Pt—Au. Hence, the electrodes 21 and 32 exposed to the measuring-object gas can possess excellent heat resistance as well as excellent inactiveness against NOx. The electrodes 21 and 32, when given excellent inactiveness against NOx, can surely prevent NOx from decomposing on these electrodes. No adverse influence is given to the measuring accuracy of NOx measurement performed by the sensor cell 4.

Furthermore, Au content in the Pt—Au is in the range from 1 wt % to 5 wt %. This effectively prevents the specific gas (NOx) from decomposing on the electrodes 21 and 32 exposed to the measuring-object gas. Meanwhile, decomposing property of oxygen can be satisfactorily assured. As described above, this embodiment provides a gas sensing element highly accurate in the measurement and excellent in response.

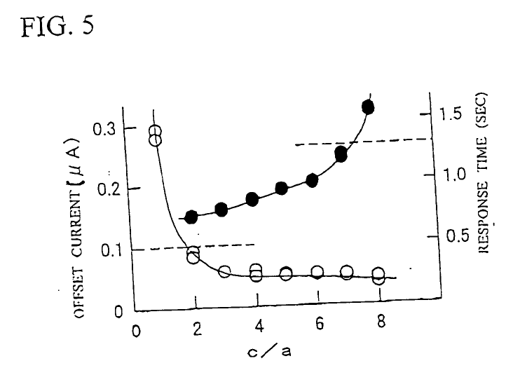

FIG. 5 shows test data showing relationship between ratio c/a, where ‘c’ represents the longitudinal length of the measured gas side pump electrode 21 and ‘a’ represents the lateral width of the same, and offset current caused in each tested gas sensing element. Furthemore, FIG. 5 shows the relationship between the ratio c/a and response time of each tested gas sensing element. The dimensions of all tested gas sensing elements are substantially identical with those of the above-described gas sensing element 1, except for variation of the ratio c/a.

As shown in FIG. 5, a total of eight kinds of sensing element samples, differentiated in the value of c/a varying from 1 to 8, were prepared to measure the offset current to be caused in each tested sample. In the test of each sensing element sample, a 63% response time was measured using NOx varying in the range from 0 to 300 ppm. In this case, the 63% response time is a time required for the sensor output to reach a 63% point of the entire change in each case that the NOx concentration varies from 0 ppm to 300 ppm and from 300 ppm to 0 ppm.

In the test data shown in FIG. 5, ◯ represents the offset current value and ● represents the response time. As apparent from FIG. 5, the offset current abruptly increases when c/a becomes smaller than approximately 2, while the response time greatly increases when c/a exceeds approximately 7. The offset current value at c/a=2.0 is approximately 0.1 μA, and the response time at c/a=7.0 is approximately 1.3 sec. From the measurement result shown in FIG. 5, it is understood that satisfying the relationship 2.0≦c/a≦7.0 brings the effect of improving measuring accuracy and assuring excellent response time.

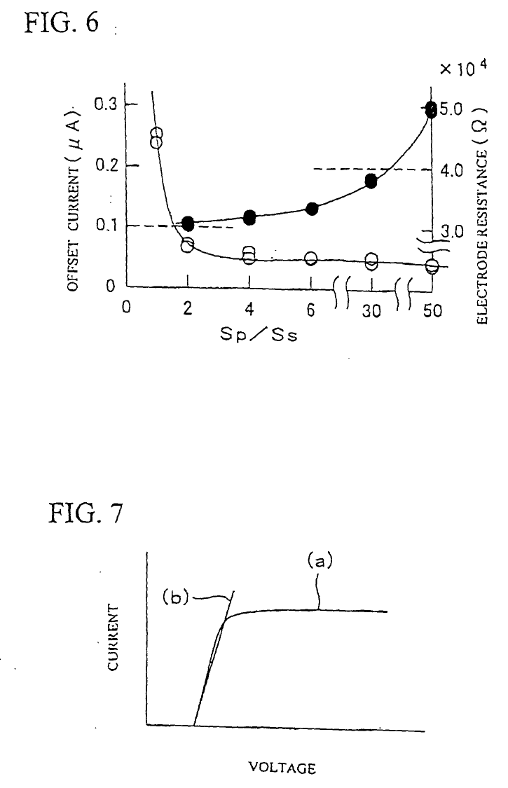

FIG. 6 shows another test data showing relationship between ratio Sp/Ss, where ‘Sp’ represents the area of the measured gas side pump electrode 21 and ‘Ss’ represents the area of the measured gas side sensor electrode 42, and the offset current caused in each tested gas sensing element. Furthermore, FIG. 6 shows the relationship between the ratio Sp/Ss and electrode resistance of the sensor cell. The dimensions of all tested gas sensing elements are substantially identical with those of the above-described gas sensing element 1, except for variation of the ratio Sp/Ss.

As shown in FIG. 6, a total of six kinds of sensing element samples, differentiated in the value of Sp/Ss taking steps of 1, 2, 4, 6, 30, and 50, were prepared to measure the offset current to be caused as well as the electrode resistance of the sensor cell in each tested sample. In this case, the electrode resistance represents ? V/? I, i.e., reciprocal of inclination, in a linearly changing portion (line b) in the voltage-current characteristics of the sensor cell shown in FIG. 7, where the sensor current changes linearly in response to the applied voltage varying from 0.2 V to 0.3 V.

In the test data shown in FIG. 6, ◯ represents the offset current value and ● represents the electrode resistance. As apparent from FIG. 6, the offset current abruptly increases when Sp/Ss becomes smaller than approximately 2, while the electrode resistance of the sensor cell greatly increases when Sp/Ss exceeds approximately 30. In other words, the electrode activity of the sensor cell is worsened. The offset current value at Sp/Ss=2 is approximately 0.1 μA, and the electrode resistance at Sp/Ss=30 is approximately 4.0×10⁴ O. From the measurement result shown in FIG. 6, it is understood that satisfying the relationship 2≦Sp/Ss≦30 brings the effect of improving measuring accuracy and assuring excellent response time.

Second Embodiment

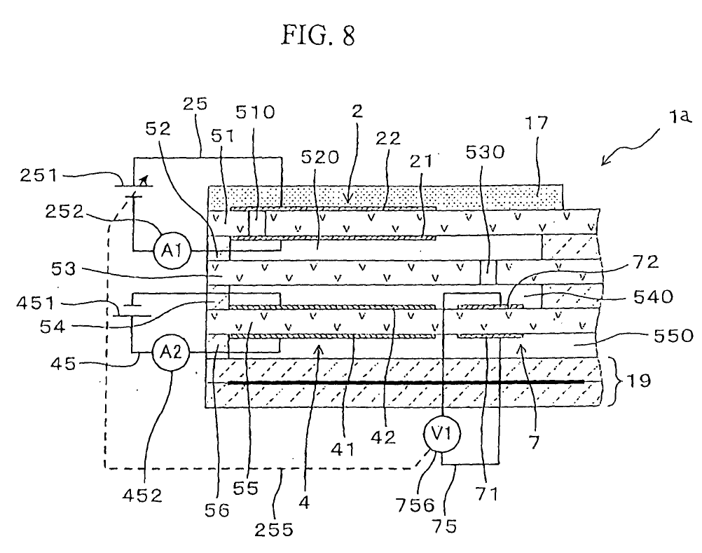

FIG. 8 shows another gas sensing element 1a in accordance with another embodiment of the present invention. According to this embodiment, a first measuring-object gas chamber 520 and a second measuring-object gas chamber 540 are offset from each other in the vertical direction normal to the surfaces of multilayered substrates including solid electrolytic substrates 51 and 55. The gas sensing element 1a of this embodiment has a multilayered structure consisting of a first solid electrolytic substrate 51, a first spacer 52, a second solid electrolytic substrate 53, a second spacer 54, a third solid electrolytic substrate 55, a third spacer 56, and a ceramic heater 19.

The first spacer 52 defines the first measuring-object gas chamber 520 interposed between the first solid electrolytic substrate 51 and the second solid electrolytic substrate 53. Similarly, the second spacer 54 defines the second measuring-object gas chamber 540 interposed between the second solid electrolytic substrate 53 and the third solid electrolytic substrate 55. The third spacer 56 defines an air chamber 550 interposed between the third solid electrolytic substrate 55 and the ceramic heater 19.

The first solid electrolytic substrate 51 has a through-hole 510 extending vertically across this body, through which a measuring-object gas is introduced into the first measuring-object gas chamber 520. A porous diffusion layer 17, accumulated on the first solid electrolytic substrate 51, covers the outer opening of the through-hole 510. The first measuring-object gas chamber 520 and the second measuring-object gas chamber 540 communicate with each other via a diffusion passage 530 extending vertically across the second solid electrolytic substrate 53.

A main pump cell 2 has a measured gas side pump electrode 21 positioned in the first measuring-object gas chamber 520 and an air side pump electrode 22 exposed to the outer atmosphere via the porous diffusion layer 17. The measured gas side pump electrode 21 and the air side pump electrode 22 are provided on opposite surfaces of the first solid electrolytic substrate 51. A sensor cell 4 has a measured gas side sensor electrode 42 positioned in the second measuring-object gas chamber 540 and a reference sensor electrode 41 positioned in the air chamber 550. The measured gas side sensor electrode 42 and the reference sensor electrode 41 are provided on opposite surfaces of the third solid electrolytic substrate 55. A monitor electromotive cell 7 has a first monitor electrode 72 positioned in the second measuring-object gas chamber 540 and a second monitor electrode 71 positioned in the air chamber 550. The first monitor electrode 72 and the second monitor electrode 71 are provided on opposite surfaces of the third solid electrolytic substrate 55.

A pump circuit 25, including a power source 251 and an ammeter 252, is connected between the measured gas side pump electrode 21 and the air side pump electrode 22 of the main pump cell 2. A monitor circuit 75, including a voltmeter 756, is connected between the first monitor electrode 72 and the second monitor electrode 71 of the monitor electromotive cell 7. A sensor circuit 45, including a power source 451 and an ammeter 452, is connected between the measured gas side sensor electrode 42 and the reference sensor electrode 41 of the sensor cell 4. Furthermore, a feedback circuit 255 is provided to control the operation of the main pump cell 2 based on the signal of the monitor electromotive cell 7. More specifically, the power source 251 in the main pump circuit 25 is feedback controlled based on the voltage signal detected by the voltmeter 756 in the monitor circuit 75.

The measured gas side pump electrode 21 is a Pt—Au electrode having inactive nature against NOx. The monitor electromotive cell 7 is composed of Pt electrodes possessing excellent catalytic activeness against O₂. The measured gas side sensor electrode 42 is a Pt—Rh electrode having active nature against NOx. The remaining electrodes 22, 71, and 41 are Pt—Rh electrodes, respectively. The measured gas side sensor electrode 42 contains Au by an amount of 0.2 wt %. The monitor electromotive cell 7 is not the pump cell of the present invention. The rest of the arrangement of this embodiment is similar to that of the first embodiment. Thus, this embodiment brings substantially the same functions and effects.

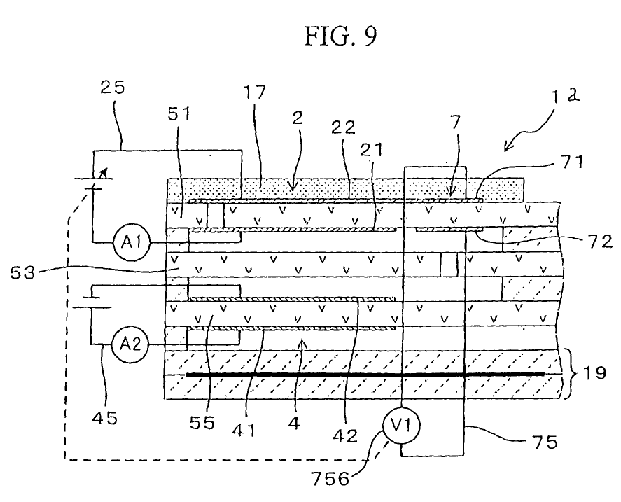

Alternatively, as shown in FIG. 9, it is possible to provide the monitor electromotive cell 7 on the first solid electrolytic substrate 51. In this case, it is possible to integrate the air side pump electrode 22 of the main pump cell 2 with the second monitor electrode 71 of the monitor electromotive cell 7.

Third Embodiment

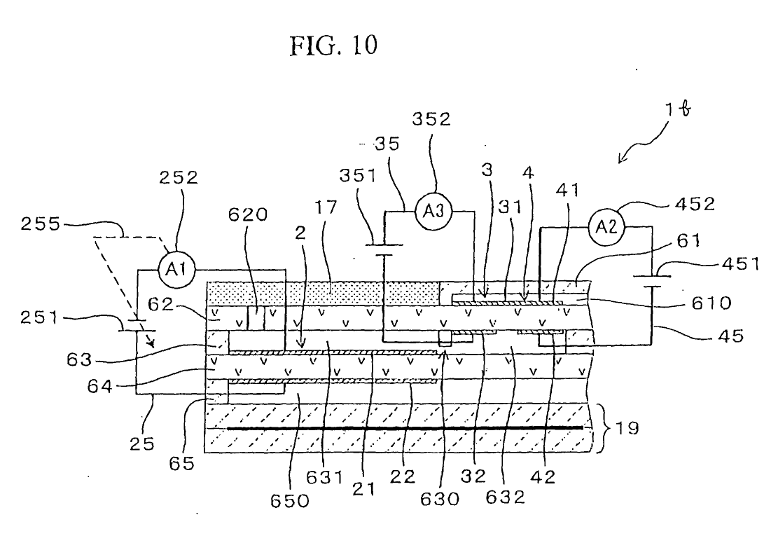

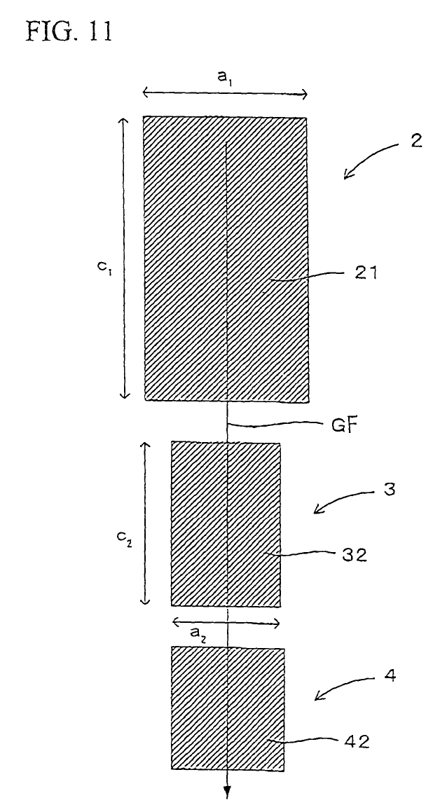

FIGS. 10 and 11 show a gas sensing element 1b in accordance with another embodiment of the present invention. According to this embodiment, as shown in FIG. 10, a sensor cell 4 and a monitor pump cell 3 are serially connected. As shown in FIG. 11, a main pump cell 2, the monitor pump cell 3, and the sensor cell 4 are disposed in series in this order from the upstream side in the flow direction (indicated by an arrow GF) of the measuring-object gas.

The gas sensing element 1b of this embodiment has a multilayered structure consisting of a first spacer 61, a first solid electrolytic substrate 62, a second spacer 63, a second solid electrolytic substrate 64, a third spacer 65, and a ceramic heater 19. The first spacer 61 defines a first air chamber (reference gas chamber) 610 underlying this spacer along an upper surface of the first solid electrolytic substrate 62. The second spacer 63 defines a first measuring-object gas chamber 631 and a second measuring-object gas chamber 632 interposed between the first solid electrolytic substrate 62 and the second solid electrolytic substrate 64. Similarly, the third spacer 65 defines a second air chamber 650 interposed between the second solid electrolytic substrate 64 and the ceramic heater 19.

The first solid electrolytic substrate 62 has a through-hole 620 extending vertically across its body, through which a measuring-object gas is introduced into the first measuring-object gas chamber 631. A porous diffusion layer 17 is accumulated on the first solid electrolytic substrate 62 so as to cover the outer opening of the through-hole 620. The first measuring-object gas chamber 631 and the second measuring-object gas chamber 632 communicate with each other via a diffusion passage 630 extending along an upper surface of the second solid electrolytic substrate 64.

The main pump cell 2 has a measured gas side pump electrode 21 positioned in the first measuring-object gas chamber 631 and an air side pump electrode 22 positioned in the second air chamber 650. The measured gas side pump electrode 21 and the air side pump electrode 22 are provided on opposite surfaces of the second solid electrolytic substrate 64. The sensor cell 4 has a measured gas side sensor electrode 42 positioned in the second measuring-object gas chamber 632 and a reference sensor electrode 41 positioned in the first air chamber 610. The measured gas side sensor electrode 42 and the reference sensor electrode 41 are provided on opposite surfaces of the first solid electrolytic substrate 62. The monitor pump cell 3 has a measured gas side monitor electrode 32 positioned in the second measuring-object gas chamber 632 and an air side monitor electrode 31 positioned in the first air chamber 610. The measured gas side monitor electrode 32 and the air side monitor electrode 31 are provided on opposite surfaces of the first solid electrolytic substrate 62.

A pump circuit 25, including a power source 251 and an ammeter 252, is connected between the measured gas side pump electrode 21 and the air side pump electrode 22 of the main pump cell 2. A monitor circuit 35, including a power source 351 and an ammeter 352, is connected between the air side monitor electrode 31 and the measured gas side monitor electrode 32 of the monitor pump cell 3. A sensor circuit 45, including a power source 451 and an ammeter 452, is connected between the reference sensor electrode 41 and the measured gas side sensor electrode 42 of the sensor cell 4. Furthermore, a feedback circuit 255 is provided to control the operation of the main pump cell 2. More specifically, the power source 251 in the pump circuit 25 is feedback controlled based on the current signal detected by the ammeter 252 in the pump circuit 25.

Each of the measured gas side pump electrode 21 and the measured gas side monitor electrode 32 is a Pt—Au electrode having inactive nature against NOx. The measured gas side sensor electrode 42 is a Pt—Rh electrode having active nature against NOx. The remaining electrodes 22, 31, and 41 are Pt—Rh electrodes, respectively. The measured gas side sensor electrode 42 contains Au by an amount of 0.2 wt %.

In this embodiment, the relationships are satisfied.

2.0≦c/a≦7.0,

2≦Sp/Ss≦30,

c=c₁+c₂, and

a=(a₁c₁+a₂c₂)/(c₁+c₂)

where c₁ represents the length of measured gas side pump electrode 21 in the longitudinal direction of the gas sensing element 1b, a₁ represents the width of measured gas side pump electrode 21 in the lateral direction of the gas sensing element 1b, c₂ represents the length of measured gas side monitor electrode 32 in the longitudinal direction of the gas sensing element 1b, and a₂ represents the width of measured gas side monitor electrode 32 in the lateral direction of the gas sensing element 1b. Furthermore, Sp represents a summed-up area of the measured gas side pump electrode 21 and the measured gas side monitor electrode 32.

In the case that a plurality of pump cells possessing pumping capability are present at the upstream side of the sensor cell in the flow direction of the measuring-object gas, ‘c’ and ‘a’ are expressed by using the following formulas.

c=Σcₙ

a=(Σaₙcₙ)/Σcₙ

where c₁, c₂, - - - , cₙ represent the longitudinal lengths of respective measures gas side pump electrodes, and a₁, a₂, - - - , aₙ represent the lateral widths of respective measures gas side pump electrodes. The rest of the gas sensing element 1b is substantially the same as that of the above-described gas sensing element 1. Accordingly, the gas sensing element 1b brings substantially the same functions and effects.

Besides the disclosed arrangement, it is possible to provide the main pump cell 2 on the first solid electrolytic substrate 62 and provide the sensor cell 4 and the monitor pump cell 3 on the second solid electrolytic substrate 64.

Fourth Embodiment

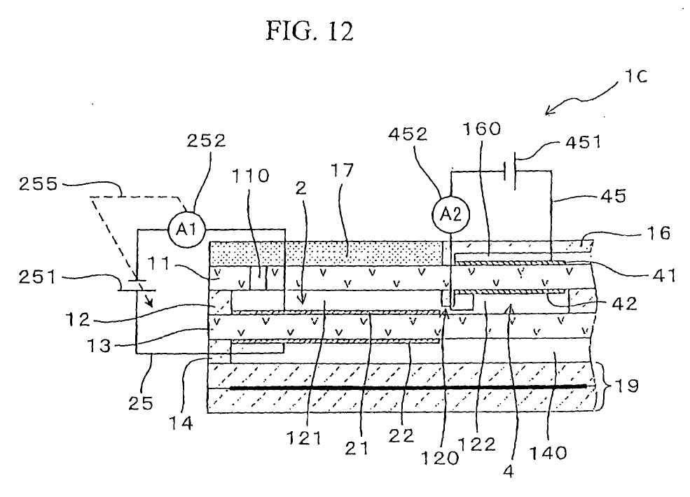

FIG. 12 shows a gas sensing element in accordance with another embodiment of the present invention which is structurally similar to the gas sensing element 1 disclosed in the fist embodiment but is different in that it is a two-cell type gas sensing element 1c having no monitor pump cell.

According to the gas sensing element 1c of this embodiment, a feedback circuit 255 is provided to feedback control the power source 251 in the pump circuit 25 based on the current signal detected by the ammeter 252 in the pump circuit 25. The rest of the arrangement of this embodiment is similar to that of the first embodiment. Thus, this embodiment brings substantially the same functions and effects.

Besides the disclosed arrangement, it is possible to provide the main pump cell 2 on the first solid electrolytic substrate 11 and provide the sensor cell 4 and the monitor pump cell 3 on the second solid electrolytic substrate 13.

Fifth Embodiment

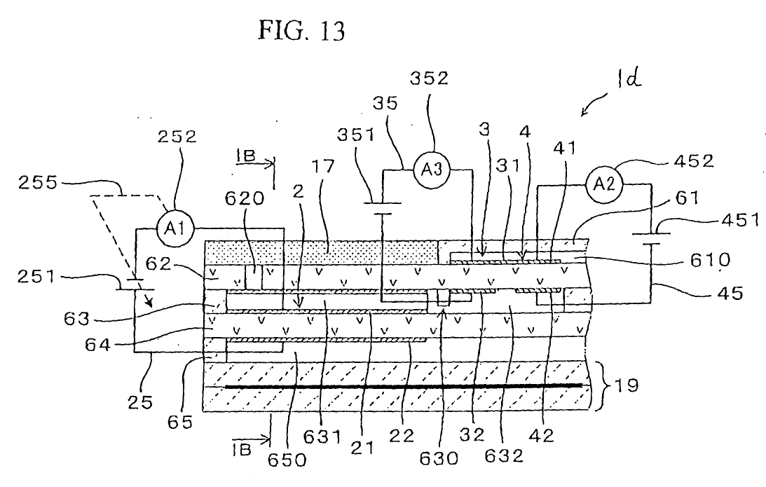

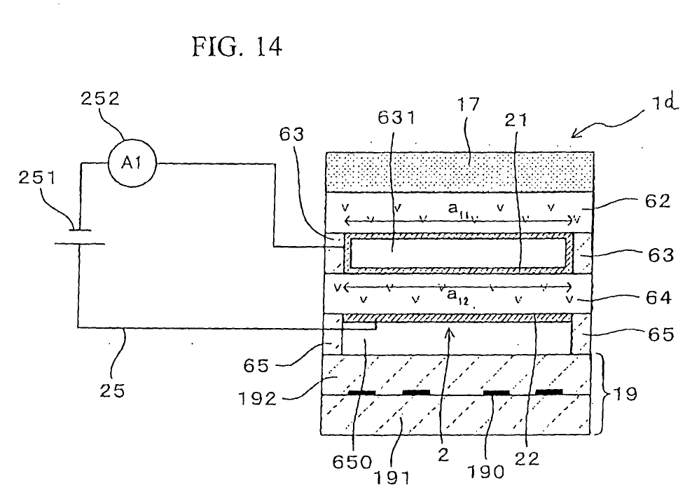

FIGS. 13 and 14 show a gas sensing element 1d in accordance with another embodiment of the present invention, characterized in that a measured gas side pump electrode 21 of the main pump cell 2 is formed on each of the upper, lower, right, and left walls of a first measuring-object gas chamber 631. More specifically, as shown in FIG. 14, the measured gas side pump electrode 21 is formed not only on the second solid electrolytic substrate 64 but also on the first solid electrolytic substrate 62 as well as on each inner side surface of the spacer 63.

In this case, the lateral width a₁ of the measured gas side pump electrode 21 is calculated by the following formula.

a₁=(a₁₁+a₁₂)/2

where a₁₁ represents the maximum width of the electrode 21 formed on the first solid electrolytic substrate 62 and a₁₂ represents the maximum width of the electrode 21 formed on the second solid electrolytic substrate 64. The length of the electrode 21 formed on each inner side surface of the spacer 63 is not taken into consideration.

Furthermore, the longitudinal length c₁ of measured gas side pump electrode 21 is the length measured at the longest portion of the same. Furthermore, the area Sp₁ is a summed-up area of the measured gas side pump electrode 21 formed on the surfaces of first solid electrolytic substrate 62, second solid electrolytic substrate 64, and spacer 63. The rest of the arrangement of the gas sensing element 1d is substantially the same as that of the gas sensing element 1b shown in FIG. 10.

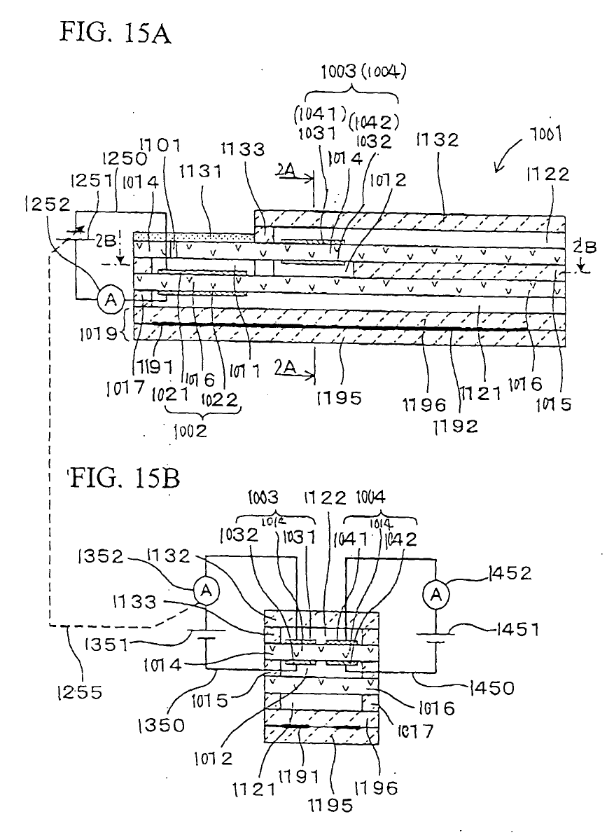

Next, another aspect of the present invention will be explained with reference to FIGS. 15A to 29.

According to this aspect of the present invention, the present invention provides a multilayered gas sensing element including a measuring-object gas chamber into which a measuring-object gas is introduced under a predetermined diffusion resistance. An oxygen pump cell having a pair of pump electrodes is provided on surfaces of an oxygen ion conductive solid electrolytic substrate, with one of the pump electrodes being positioned in the measuring-object gas chamber, for pumping oxygen into or from the measuring-object gas chamber in response to electric power supplied to the pump electrodes to adjust an oxygen concentration in the measuring-object gas chamber. And, a sensor cell having a pair of sensor electrodes is provided on surfaces of an oxygen ion conductive solid electrolytic substrate, with one of the sensor electrodes being positioned in the measuring-object gas chamber, for detecting a specific gas concentration in the measuring-object gas chamber based on an oxygen ion current produced between the sensor electrodes.

The pump electrode positioned in the measuring-object gas chamber has a side surface extending in a longitudinal direction of the gas sensing element and facing via a clearance region to an inside surface of the measuring-object gas chamber, and a minimum value of a total width G of the clearance region in a transverse direction of the gas sensing element is not greater than 0.5 mm.

Furthermore, the pump electrode positioned in the measuring-object gas chamber has a downstream portion positioned at a downstream side of a measuring-object gas introducing hole in a flow direction of the measuring-object gas, and the downstream portion of the pump electrode satisfies the following relationship

Sg/Se≦0.3

where Se represents an area of the downstream portion of the pump electrode, and Sg represents the total area of a clearance region residing between a side surface of the downstream portion of the pump electrode extending in a longitudinal direction of the gas sensing element and an inside surface of the measuring-object gas chamber.

According to the multilayered gas sensing element of the present invention, the pump electrode of the oxygen pump cell can be configured into a rectangular shape having a uniform transverse width, an irregular rectangular shape with a transverse width varying in the longitudinal direction, an oval shape, or any other shape. Meanwhile, the measuring-object gas chamber can be configured into any shape. However, to reduce the clearance between the side surface of the pump electrode and the inside surface of the measuring-object gas chamber, it is preferable that the measuring-object gas chamber is configured into the shape corresponding to the pump electrode.

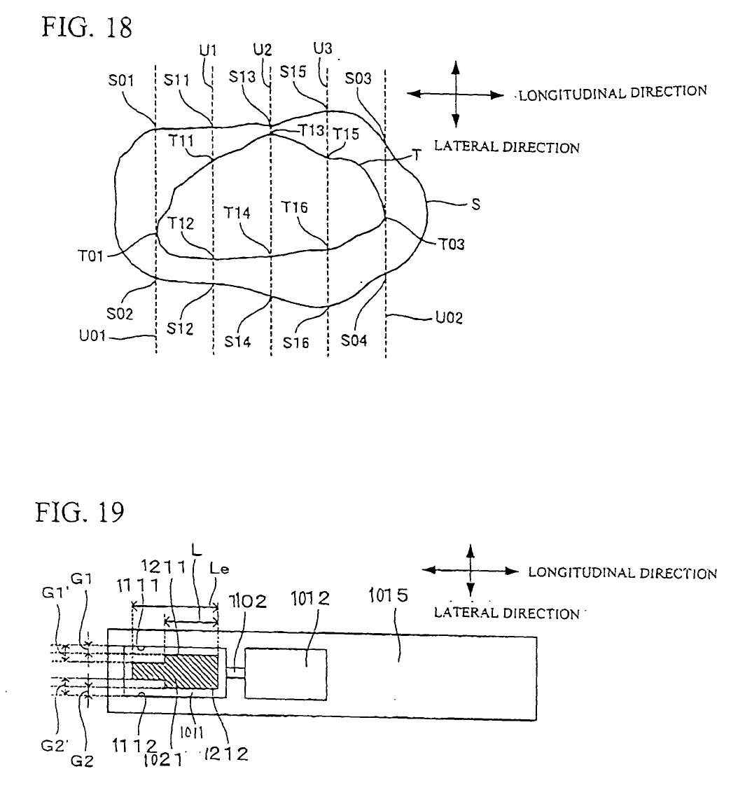

Regarding the total width G of the clearance region in the transverse direction of the gas sensing element, it will be explained in more detail with reference to FIG. 18 (i.e., a horizontal cross-sectional view schematically showing relationship between the pump electrode and the measuring-object gas chamber) in which a curve S represents the inside surface of the measuring-object gas chamber and a curve T represents the side surface of the pump electrode. A line U01 passes one longitudinal end (T01) of the pump electrode, and a line U02 passes the other longitudinal end (T03) of the pump electrode. Each of lines U1 to U3 crosses the pump electrode. All of the lines U01, U02, and U1-U3 are normal to the longitudinal direction of the multilayered gas sensing element. Respective lines U01, U02, and U1-U3 cross with the curves S and T at points S01 to S04, S11 to S16, and T11 to T16.

According to FIG. 18, the total width G of the clearance region is expressed by a sum of distance S11-T11 and distance S12-T12 when taken along the line U1, or by a sum of distance S13-T13 and distance S14-T14 when taken along the line U2, or by a sum of distance S15-T15 and distance S16-T16 when taken along the line U3. Alternatively, the total width G of the clearance region is expressed by a distance S01-S02 when taken along the line U01 or by a distance S03-S04 when taken along the line U02. According to the multilayered gas sensing element of the present invention, the total width G of the clearance region becomes 0.5 mm or less somewhere along the side surface of the pump electrode. In the example shown in FIG. 18, the total width G of the clearance region is smallest on the line U2. Thus, the sum of distance S13-T13 and distance S14-T14 is not larger than 0.5 mm. The above-described method of obtaining the total width G of the clearance region is equally applied to each curve T if a plurality of curves each representing the pump electrode are present in the measuring-object gas chamber.

Setting the total width G of the clearance region so as not to be greater than 0.5 mm makes it possible to assure excellent sensing accuracy. To obtain more excellent sensing accuracy, it is preferable that the total width G of the clearance region is not greater than 0.2 mm. It is needless to say that reducing the total width G to 0 mm is ideal. In this case, the side surface of the pump electrode is brought into contact with the inside surface of the measuring-object gas chamber. The longitudinal direction of the multilayered gas sensing element corresponds to a major axis of the multilayered gas sensing element when it has a rectangular cross-sectional shape.

Preferably, the longitudinal length of the portion of the pump electrode where the clearance region has the total width not greater than 0.5 mm is not shorter than ¼ of an entire longitudinal length of the pump electrode positioned in the measuring-object gas chamber. To obtain more excellent sensing accuracy, it is preferable that the longitudinal length of the above-identified portion of the pump electrode is not smaller than ½ of the entire longitudinal length of the pump electrode.

Furthermore, regarding the relationship between the area Se of the pump electrode and the total area Sg of the clearance region in the downstream portion of the pump electrode, it will be explained in more detail with reference to FIG. 21 (i.e., a horizontal cross-sectional view schematically showing relationship between the pump electrode and the measuring-object gas chamber) in which a curve S represents the inside surface of the measuring-object gas chamber and a curve T represents the side surface of the pump electrode. In FIG. 21, a point V represents the center of a measuring-object gas introducing hole, a line V0 represents a transverse line passing the point V, and a line V1 represents a transverse line passing the downstream end of the pump electrode in the longitudinal direction. The area Se of the pump electrode positioned at the downstream side of the measuring-object gas is depicted as a region surrounded by the curve T and the line V0. The total area Sg of the clearance region is a sum of regions surrounded by the lines V0 and V1 and curves T and S.

According to another multilayered gas sensing element introducing a measuring-object gas from a side surface, the entire region of the pump electrode is positioned at the downstream side of the measuring-object gas introducing hole. In this case, Se is equal to the entire area of the pump electrode, and the line V0 crosses the upstream end of the pump electrode. In the relationship between the pump electrode and the clearance region, setting the ratio Sg/Sg to be not greater than 0.3 makes it possible to assure excellent sensing accuracy. It is needless to say that reducing the area Sg to 0 is ideal. In this case, the side surface of the pump electrode is brought into contact with the inside surface of the measuring-object gas chamber.

The multilayered gas sensing element of the present invention can be embodied as a NOx sensing element, a CO sensing element, a HC sensing element, or any other type of sensing element having two cells or more.

Preferably, the multilayered gas sensing element of the present invention further includes an oxygen monitor cell having a pair of monitor electrodes provided on surfaces of an oxygen ion conductive solid electrolytic substrate, with one of the monitor electrodes being positioned in the measuring-object gas chamber, for detecting the oxygen concentration in the measuring-object gas chamber based on a current value or an electromotive force produced between the monitor electrodes.

For example, it is preferable to add an arrangement for controlling the operation of the oxygen pump cell so that the oxygen concentration in the measuring-object gas chamber can be maintained in a predetermined range. In this case, the oxygen ion current flowing between two sensor electrodes accurately reflects the concentration of a specific gas. The oxygen monitor cell detecting the oxygen concentration based on a current value functions as a limit-current type oxygen sensor. The oxygen monitor cell detecting the oxygen concentration based on an electromotive force functions as an oxygen concentration cell type oxygen sensor.

Sixth Embodiment

Hereinafter, a multilayered gas sensing element in accordance with a preferable embodiment of the present invention will be explained.

As shown in FIGS. 15A and 15B, a multilayered gas sensing element 1001 of this embodiment includes a measuring-object gas chamber (1011, 1012) into which a measuring-object gas is introduced under a predetermined diffusion resistance. An oxygen pump cell 1002 has a pair of pump electrodes 1021 and 1022 provided on opposite surfaces of an oxygen ion conductive solid electrolytic substrate 1016. One pump electrode 1021 is positioned in the measuring-object gas chamber 1011. The oxygen pump cell 1002 has the capability of pumping oxygen into or from the measuring-object gas chamber 1011 in response to electric power supplied to the pump electrodes 1021 and 1022 to adjust an oxygen concentration in the measuring-object gas chamber 1011. A sensor cell 1004 has a pair of sensor electrodes 1041 and 1042 provided on opposite surfaces of an oxygen ion conductive solid electrolytic substrate 1014. One sensor electrode 1042 is positioned in a measuring-object gas chamber 1012. The sensor cell 1004 has the capability of detecting a specific gas concentration in the measuring-object gas chamber 1012 based on an oxygen ion current produced between the sensor electrodes 1041 and 1042.

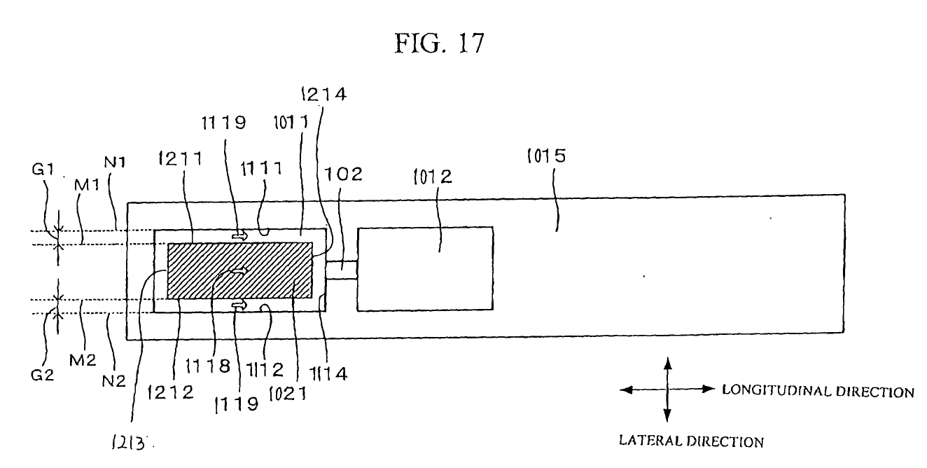

As shown in FIG. 17, the pump electrode 1021 of the oxygen pump cell 1002 positioned in the measuring-object gas chamber 1011 has side surfaces 1211 and 1212 extending in the longitudinal direction of the gas sensing element 1001 and facing via a clearance region to inside surfaces 1111 and 1112 of the measuring-object gas chamber 1011. A total width G (=G1+G2) of the clearance region in a transverse direction of the gas sensing element 1001 is not greater than 0.5 mm.

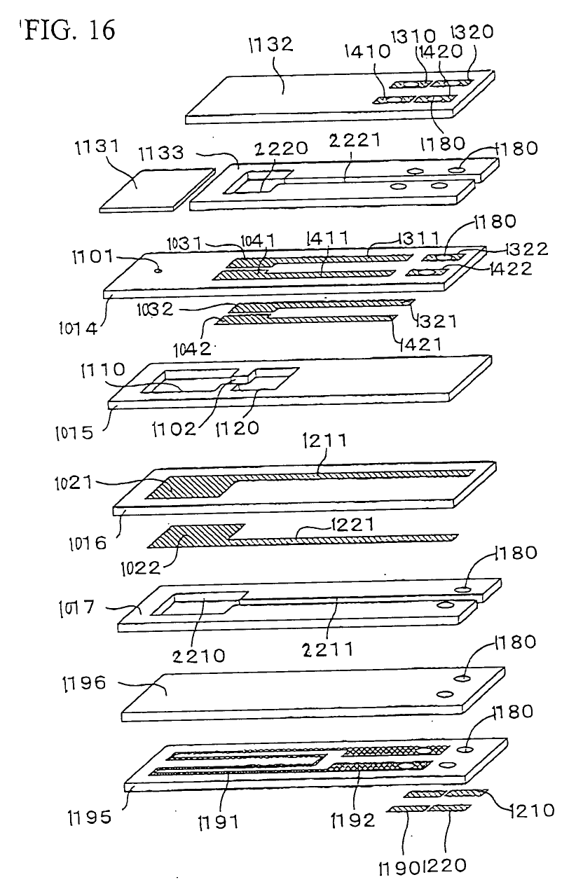

More specifically, as shown in FIGS. 15A, 15B, and 16, the multilayered gas sensing element 1001 of this embodiment includes the solid electrolytic substrate 1016 configured into a sheet body constituting part of the oxygen pump cell 1002, the solid electrolytic substrate 1014 configured into a sheet body constituting part of the oxygen monitor cell 1003 and the sensor cell 1004, a spacer 1015 defining the first measuring-object gas chamber 1011 and the second measuring-object gas chamber 1012, spacers 1017, 1133, and 1132 defining reference gas chambers 1121 and 1122, and a heater 1019 heating respective cells 1002, 1003, and 1004, which are stacked or laminated successively.

The first measuring-object gas chamber 1011 and the second measuring-object gas chamber 1012 are inner chambers formed in the sensing element body into which the measuring-object gas is introduced. As shown in FIG. 16, the spacer 1015 interposing between two solid electrolytic substrates 1014 and 1016 has two rectangular apertures 1110 and 1120 which serve as the first measuring-object gas chamber 1011 and the second measuring-object gas chamber 1012, respectively. The apertures 1110 and 1120 are connected via an orifice 1102 having a narrow width compared with the width of respective apertures 1110 and 1120.

The first measuring-object gas chamber 1011 is connected to the outside of the sensing element via a pinhole 1101 extending vertically across the solid electrolytic substrate 1014. The pinhole 1101 serves as a diffusion resistance element. The radial size of the pinhole 1101 is determined to an appropriate value considering a desired diffusion rate with which the measuring-object gas can diffuse from the first measuring-object gas chamber 1011 to the second measuring-object gas chamber 1012.

A porous protecting layer 1131, made of a porous alumina or the like, is provided on the solid electrolytic substrate 1014 so as to completely cover the outer opening of the pinhole 1101. The porous protecting layer 1131 has the capability of protecting the electrodes 1021, 1032, and 1042 positioned in the measuring-object gas chambers 1011 and 1012 from being subjected to poisonous substances. Furthermore, the porous protecting layer 1131 prevents the pinhole 1101 from clogging.

The reference gas chambers 1121 and 1122 are inner chambers storing the air serving as a reference gas having a standard oxygen concentration. The spacer 1017 underlying the solid electrolytic substrate 1016 has a rectangular aperture 2210 serving as the reference gas chamber 1121. The spacer 1133 overlying on the solid electrolytic substrate 1014 has a rectangular aperture 2220 serving as the reference gas chamber 1122. The apertures 2210 and 2220 are connected to the outside of the sensing element body via passages 2211 and 2221 extending in the longitudinal direction of the multilayered gas sensing element 1001.

The oxygen pump cell 1002 is composed of the solid electrolytic substrate 1016 and a pair of pump electrodes 1021 and 1022 provided on the opposite surfaces of the solid electrolytic substrate 1016. One pump electrode 1021 is positioned in the first measuring-object gas chamber 1011 located at an upstream side of the second measuring-object gas chamber 1012 in the flow direction of the measuring-object gas. The other pump electrode 1022 is positioned in the reference gas chamber 1121.

The sensor cell 1004 is composed of the solid electrolytic substrate 1014 and a pair of sensor electrodes 1041 and 1042 provided on the opposite surfaces of the solid electrolytic substrate 1014. One sensor electrode 1042 is positioned in the second measuring-object gas chamber 1012 located at a downstream side of the first measuring-object gas chamber 1011 in the flow direction of the measuring-object gas. The other sensor electrode 1041 is positioned in the reference gas chamber 1122.

The oxygen monitor cell 1003 is composed of the solid electrolytic substrate 1014 and a pair of monitor electrodes 1031 and 1032 provided on the opposite surfaces of the solid electrolytic substrate 1014. One monitor electrode 1032 is positioned in the second measuring-object gas chamber 1012 located at a downstream side of the first measuring-object gas chamber 1011 in the flow direction of the measuring-object gas. The other monitor electrode 1031 is positioned in the reference gas chamber 1122.

Furthermore, as shown in FIG. 16, these electrodes 1021, 1022, 1031, 1032, 1041, and 1042 are integrally formed with lead portions 1211, 1221, 1311, 1321, 1411, and 1421 for sending electric signals or for receiving electric power from an electric power source. It is preferable to provide an alumina or comparable insulating layer intervening between the solid electrolytic substrates 1014 and 1016 and the lead portions 1211, 1321, 1421 etc, except for the portions where the pump electrode 1021 or the like are disposed.

Furthermore, as shown in FIG. 16, the electrodes of respective cells 1002, 1003, and 1004 are electrically connected to external terminals 1310, 1320, 1410, 1420, 1210, and 1220 via their lead portions and through holes 1180 extending vertically across the spacer 1017 or the like. Signal lead lines are connected to the external terminals of respective cells 1002, 1003, and 1004 by using appropriate connectors or equivalent means to send the detection signals or receive electric power to or from external circuits. In the drawings, reference numerals 1322 and 1422 are internal terminals connected to the lead portions 1321 and 1421, respectively.

A pump circuit 1250, including a pump power source 1251 and an ammeter 1252, is connected to the oxygen pump-cell 1002. A monitor circuit 1350, including a power source 1351 and an ammeter 1352, is connected to the oxygen monitor cell 1003. A sensor circuit 1450, including a power source 1451 and an ammeter 1452, is connected to the sensor cell 1004.

The heater 1019 includes a heat generating element 1191 generating heat in response to electric power supplied from an external power source (not shown). The heater 1019 has the capability of heating respective cells 1002, 1003, and 1004 to their activation temperatures. The heater 1019 includes an alumina heater substrate 1195, the heat generating element 1191 patterned on the upper surface of the heater substrate 1195, and an insulating plate 1196 overlying the heat generating element 1191. As apparent from FIG. 16, heater terminals 1190 and external terminals 1210 and 1220 are provided on a lower surface of the sensing element 1001 closer to the heater 1019. The external terminals 1310, 1320, 1410, and 1420 are disposed on an upper surface of the sensing element 1001 closer to the spacer 1132.

Next, dimensional relationship between the pump electrode 1021 and the first measuring-object gas chamber 1011 will be explained hereinafter.

As shown in FIG. 17, each of the pump electrode 1021 and the first measuring-object gas chamber 1011 is configured into a rectangular shape extending in the longitudinal direction of the gas sensing element 1001. M1 represents an extension line of one side surface 1211 of the pump electrode 1021. N1 represents an extension line of the inside surface 1111 of the measuring-object gas chamber 1011 which is opposed to the side surface 1211 of the pump electrode 1021. Two lines M1 and N1 are parallel to each other with a uniform clearance G1 in the region ranging from one end 1213 to the other end 1214 of the pump electrode 1021. M2 represents an extension line of the other side surface 1212 of the pump electrode 1021. N2 represents an extension line of the inside surface 1112 of the measuring-object gas chamber 1011 which is opposed to the side surface 1212 of the pump electrode 1021. Two lines M2 and N2 are parallel to each other with a uniform clearance G2 in the region ranging from one end 1213 to the other end 1214 of the pump electrode 1021. Accordingly, the total width G of the clearance region intervening between the side surfaces 1211 and 1212 of the pump electrode 1021 and the inside surfaces 1111 and 1112 of the measuring-object gas chamber 1011 is expressed by the sum of G1 and G2 (i.e., G=G1+G2). According to this embodiment, G is not greater than 0.5 mm.

Compositions of respective members constituting the above-described multilayered gas sensing element 1001 will be explained hereinafter.

Each of the spacers 1017, 1015, 1133, and 1132 is made of an alumina or comparable insulating material. Each of the solid electrolytic substrates 1014 and 1016 constituting the oxygen pump cell 1002, the oxygen monitor cell 1003, and the sensor cell 1004 is made of an oxygen ion conductive ceramic, such as zirconia. Each of the pump electrode 1021 and the monitor electrode 1032 possesses inactive nature against NOx, so as to suppress decomposition of NOx in the first measuring-object gas chamber 1011 and the second measuring-object gas chamber 1012. For example, the pump electrode 1021 and the monitor electrode 1032 is a porous cermet electrode containing Pt and Au. In this case, it is preferable that Au content in the metallic component is in the range from 1 wt % to 10 wt %.

Furthermore, the sensor electrode 1042 positioned in the second measuring-object gas chamber 1012 possesses active nature against NOx so as to decompose NOx in the measuring-object gas. For example, the sensor electrode 1042 is a porous cermet electrode containing Pt and Rh. In this case, it is preferable that Rh content in the metallic component is in the range from 10 wt % to 50 wt %.

Each of the solid electrolytic substrates 1014, 1016, the spacers 1015, 1017, 1133, and 1132, and the alumina insulating plate 1196, and the heater substrate 1195 is configured into a plate shape by the doctor blade method or extraction molding method. Furthermore, each of the electrodes, leads and terminals is formed by the screen printing. Respective sheets are laminated and sintered into an integrated multilayered body.

Furthermore, each of the pump electrode 1022, the monitor electrode 1031, and the sensor electrode 1041 positioned in the reference gas chambers 1121 and 1122 is a Pt porous cermet electrode. The heat generating element 1191 and the heater lead 1192 is made of a cermet member containing Pt and alumina ceramic.

The above-described multilayered gas sensing element operates in the following manner.

The measuring-object gas is introduced into the first measuring-object gas chamber 1011 via the porous protecting layer 1131 and the pinhole 1101. The amount of introduced measuring-object gas is dependent on the diffusion resistances of the porous protecting layer 1131 and the pinhole 1101. Then, the measuring-object gas is introduced into the second measuring-object gas chamber 1012 via the orifice 1102.

When a positive voltage is applied from the pump power source to the pump electrode 1022 positioned in the reference gas chamber 1121, oxygen contained in the measuring-object gas is reduced on the pump electrode 1021 positioned in the first measuring-object gas chamber 1011. The reduced oxygen becomes oxygen ion and is discharged from the pump electrode 1022 by the pumping function of the oxygen pump cell 1002.

On the contrary, when a positive voltage is applied to the pump electrode 1021 positioned in the first measuring-object gas chamber 1011, oxygen contained in the measuring-object gas is reduced on the pump electrode 1022 positioned in the reference gas chamber 1121. The reduced oxygen becomes oxygen ion and is discharged from the pump electrode 1021 by the pumping function of the oxygen pump cell 1002. Through this oxygen pumping function, the oxygen concentration in each of the first measuring-object gas chamber 1011 and the second measuring-object gas chamber can be controlled. In this case, ionization of oxygen is sufficiently performed in the stream of measuring-object gas passing on the pump electrode 1021 indicated by an arrow 1118. However, ionization of oxygen is insufficient in the stream of measuring-object gas indicated by an arrow 1119.

When a positive voltage (e.g., 0.40 V) is applied to the monitor electrode 1031 positioned in the reference gas chamber 1122, oxygen contained in the measuring-object gas is reduced on the monitor electrode 1032 positioned in the second measuring-object gas chamber 1012. The reduced oxygen becomes oxygen ion and is discharged from the monitor electrode 1031 by the pumping function of the oxygen monitor cell 1003. As the monitor electrode 1032 is a Pt—Au cermet electrode inactive against NOx, the oxygen ion current flowing between the monitor electrodes 1031 and 1032 is dependent on the oxygen amount contained in the measuring-object gas reaching the monitor electrode 1032 via the porous protecting layer 1131, the pin hole 1101, and the first measuring-object gas chamber 1011, and is not dependent on the NOx amount. Accordingly, by controlling the voltage applied between the pump electrodes 1021 and 1022 in such a manner that the current value between the monitor electrodes 1031 and 1032 becomes constant (e.g., 0.2 μA), the oxygen concentration in the second measuring-object gas chamber 1012 can be maintained at a constant value.

A positive voltage (e.g., 0.40 V) is applied to the sensor electrode 1041 positioned in the reference gas chamber 1122. As the sensor electrode 1042 is a Pt—Rh cermet electrode active against NOx, oxygen and NOx contained in the measuring-object gas are reduced on the sensor electrode 1042 positioned in the second measuring-object gas chamber 1012. The reduced oxygen becomes oxygen ion and is discharged from the sensor electrode 1041 by the pumping function of the sensor cell 1004.

The multilayered gas sensing element 1001 of this embodiment controls the oxygen pump cell 1002 in such a manner that the current value between the monitor electrodes 1031 and 1032 of the monitor cell 1003 becomes constant (e.g., 0.2 μA). In this case, if no NOx is contained in the measuring-object gas, the current value between the sensor electrodes 1041 and 1042 of the sensor cell 1004 will become constant (e.g., 0.2 μA). On the other hand, if NOx is present in the measuring-object gas, the current value will increase in accordance with the NOx concentration. Accordingly, it becomes possible to detect the NOx concentration in the measuring-object gas.

The multilayered gas sensing element of this embodiment has the following functions and brings the following effects.

According to the multilayered gas sensing element 1001, as shown in FIG. 17, the total width G of the clearance region intervening between the side surfaces 1211 and 1212 of the pump electrode 1021 and the inside surfaces 1111 and 1112 of the measuring-object gas chamber 1011 is not greater than 0.5 mm. In other words, the total width G of the clearance region is sufficiently narrow. Hence, it becomes possible to reduce the oxygen concentration in the measuring-object gas chambers 1011 and 1012, so that no adverse influence of oxygen is given to the measurement of NOx concentration. Thus, it becomes possible to perform accurate measurement of a specific gas concentration.

As described above, according to the above-described preferred embodiment of the present invention, it becomes possible to provide a multilayered gas sensing element capable of accurately detecting the concentration of a specific gas (e.g., NOx) without being adversely influenced by the oxygen contained in the measuring-object gas chamber.

FIG. 18 shows generalized relationship between a pump electrode and a first measuring-object gas chamber each being configured into an arbitrary shape. According to the illustration shown in FIG. 18, the total width G of the clearance region is variable depending on the longitudinal position of the line taken for measuring the clearance. In such a case, the effects of this embodiment can be obtained when a minimum value of the total width G is not greater than 0.5 mm.

FIG. 19 shows a modified pump electrode 1021 of a gas sensing element in accordance with the preferred embodiment of the present invention, in which the total width of the clearance region is variable depending on the longitudinal position. More specifically, the pump electrode 1021 shown in FIG. 19 is configured into a stepped shape. The left part of pump electrode 1021 is narrower than the right part of pump electrode 1021. A clearance G1 is provided between the right part of side surface 1211 of the pump electrode 1021 and the inside surface 1111 of the measuring-object gas chamber 1011. A clearance G1′ is provided between the left part of side surface 1211 of the pump electrode 1021 and the inside surface 1111 of the measuring-object gas chamber 1011. A clearance G2 is provided between the right part of side surface 1212 of the pump electrode 1021 and the inside surface 1112 of the measuring-object gas chamber 1011. A clearance G2′ is provided between the left part of side surface 1212 of the pump electrode 1021 and the inside surface 1112 of the measuring-object gas chamber 1011. The wider portion of the pump electrode 1021 has a longitudinal length L. The overall longitudinal length of the pump electrode 1021 is Le.

The overall width G of the clearance region is G1′+G2′ (=0.8 mm) at the left part of the pump electrode 1021 and G1+G2 (=0.4 mm) at the right part of the pump electrode 1021. Regarding longitudinal lengths of the pump electrode 1021, Le is 6 mm and L is 4 mm.

Accordingly, the longitudinal length (L) of the portion of the pump electrode 1021 where the total width G of the clearance region is not greater than 0.5 mm is not shorter than ¼ of the entire longitudinal length (Le) of the pump electrode 1021. Thus, it becomes possible to provide an accurate multilayered gas sensing element. The rest of this modified embodiment is substantially identical with that of the sixth embodiment.

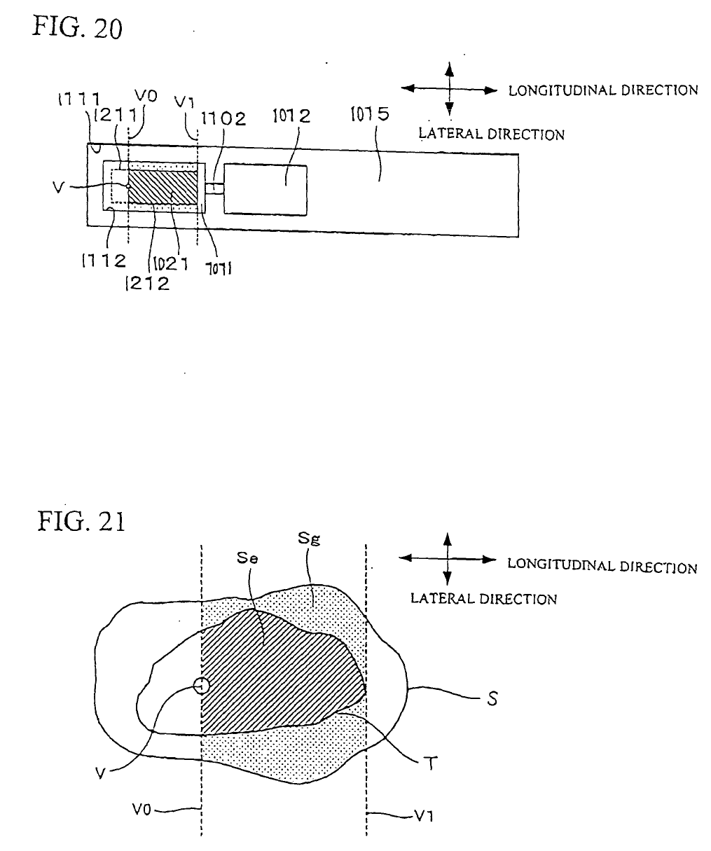

FIG. 20 shows the positional relationship between the pump electrode 1021 and the pinhole 1101. The point V represents the center of pinhole 1101. The transverse line V0 passes the point V. The transverse line V1 passes the downstream end of the pump electrode 1021.

In the range extending from the transverse line V0 to the transverse line V1, the area Se of the pump electrode 1021 positioned at the downstream side of the pinhole 1101 (i.e., the downstream of line Vo passing the point V) is 10 mm² and the total area Sg of the clearance region intervening between the side surfaces 1211 and 1212 of pump electrode 1021 and the inside surfaces 1111 and 1112 of the first measuring-object chamber 1011 is 1.5 mm². Thus, the condition Sg/Se≦0.3 is satisfied. Accordingly, almost all of the measuring-object gas can pass on the pump electrode 1021 of the oxygen pump cell 1002. Hence, it becomes possible to reduce the oxygen concentration in the measuring-object gas chambers 1011 and 1012, so that no adverse influence of oxygen is given to the measurement of NOx concentration. Thus, it becomes possible to perform accurate measurement of a specific gas concentration.

FIG. 21 shows generalized relationship between the pump electrode and the first measuring-object gas chamber each being configured into an arbitrary shape. According to the illustration shown in FIG. 21, the downstream portion of pump electrode positioned at the downstream side of the measuring-object gas introducing hole satisfies the relationship Sg/Se≦0.3.

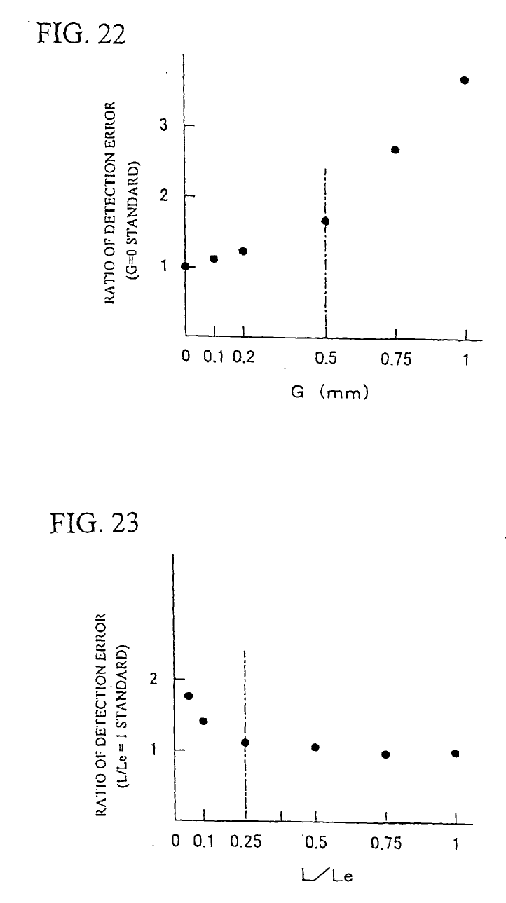

FIG. 22 is a graph showing test data representing detection errors in respective test samples of the multilayered gas sensing element which are differentiated in the value of G. In FIG. 22, an ordinate represents a ratio of detection error of each detection error relative to the standard detection error obtained in the case of G=0.

The detection error was measured in the following manner.

Each test sample of the multilayered gas sensing element was exposed in a measuring-object gas containing 100 ppm of NO in which the oxygen concentration was varied in the range from 10 ppm to 20%. When the clearance becomes large, i.e., when G becomes large, the oxygen having not been discharged by the oxygen pump cell increases and accordingly the detection error of the oxygen concentration becomes large. This measurement was conducted based on this principle. As apparent from the graph of FIG. 22, the detection error increases with increasing G. Hence, satisfying G≦0.5 mm (more preferably 0.2 mm) is essentially required to assure excellent detection accuracy.

FIG. 23 is a graph showing another test data representing detection errors in respective test samples of the multilayered gas sensing element which are differentiated in the value of L/Le. In FIG. 23, an ordinate represents a ratio of detection error of each detection error relative to the standard detection error obtained in the case of L/Le=1. As apparent from the graph of FIG. 23, the detection error increases when L/Le is small. Hence, under the condition G≦0.5 mm is satisfied, it is preferable that satisfying L/Le≦0.25 to assure excellent detection accuracy.

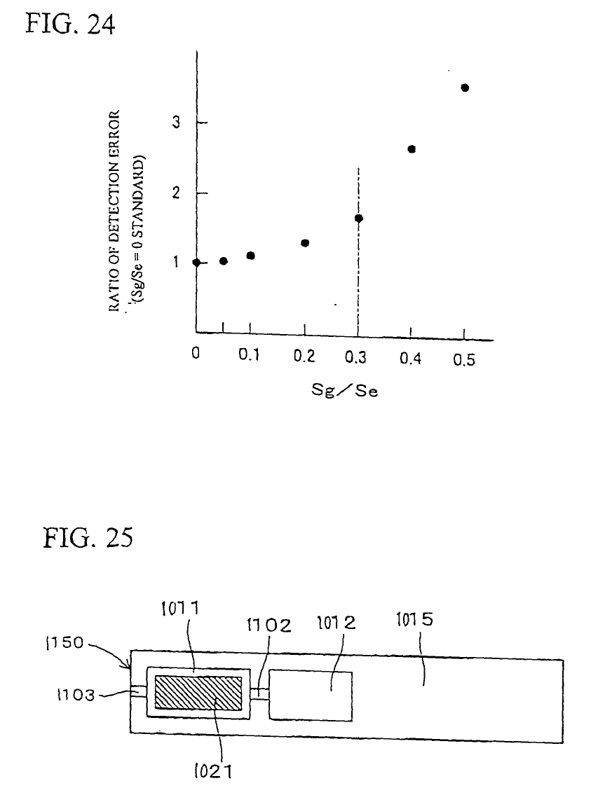

FIG. 24 is a graph showing another test data representing detection errors in respective test samples of the multilayered gas sensing element which are differentiated in the value of Sg/Se. In FIG. 24, an ordinate represents a ratio of detection error of each detection error relative to the standard detection error obtained in the case of Sg/Se=0. As apparent from the graph of FIG. 24, the detection error increases with increasing Sg/Se. Hence, satisfying Sg/Se≦0.3 is essentially required to assure excellent detection accuracy.

FIG. 25 shows a modified arrangement of the above-described sixth embodiment, characterized in that a pinhole 1103 is provided on a distal end 1150 of the sensing element body so that the measuring-object gas can be introduced from the front end to the first measuring-object gas chamber 1011. In this case, the entire region of the pump electrode 1021 is positioned at the downstream side of the pinhole 1103. Even in this embodiment, the above-described conditions are satisfied.

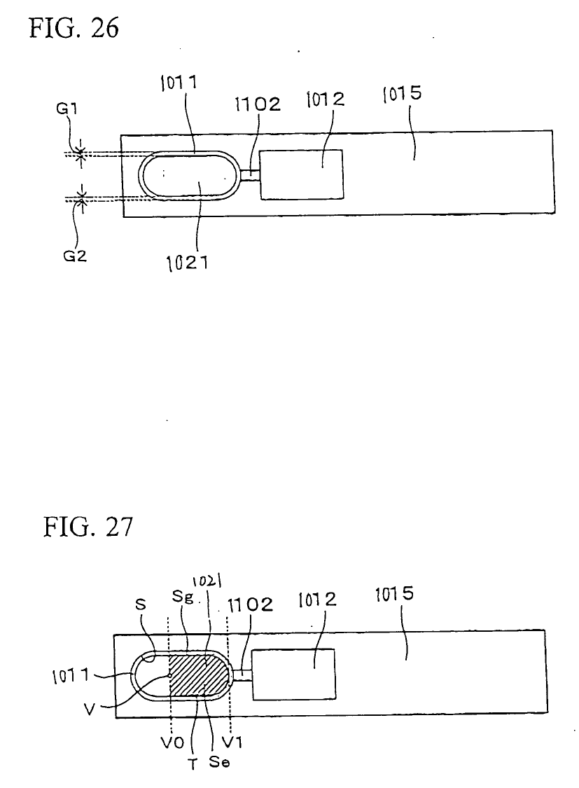

FIGS. 26 and 27 show another modified arrangements of the above-described sixth embodiment, characterized in that each of the pump electrode 1021 and the first measuring-object gas chamber 1011 is configured into an oval shape. In FIG. 26, the total width G1+G2 of the clearance region between the side surfaces 1211 and 1212 of pump electrode 1021 and the inside surfaces 2111 and 2112 of the first measuring-object gas chamber 1011 is not greater than 0.5 mm.

In FIG. 27, a curve S represents an inside surface of the first measuring-object gas chamber 1011 and a curve T represents a side surface of the pump electrode 1021. A point V represents the center of pinhole (not shown). A transverse line V0 passes the point V. A transverse line V1 passes the downstream end of the pump electrode 1021. The pump electrode 1021 has an area Se positioned at the downstream side of the pinhole (i.e., downstream of line V0 passing the point V). In the range extending from the transverse line V0 to the transverse line V1, the clearance region has an area Sg intervening between the side surface T of pump electrode 1021 and the inside surface S of the first measuring-object chamber 1011. The condition Sg/Se≦0.3 is satisfied.

Seventh Embodiment

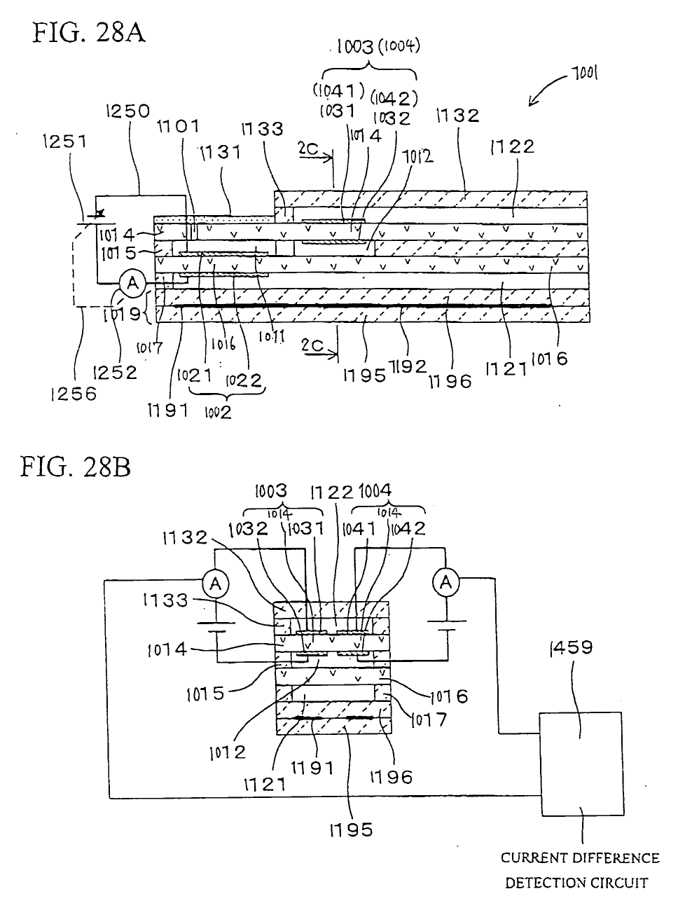

FIGS. 28A and 28B show a multilayered gas sensing element in accordance with another embodiment of the present invention, differentiated from the multilayered gas sensing element shown in FIGS. 15A and 15B in its circuit arrangement. More specifically, a pump circuit 1250 including a power source 1251 and an ammeter 1252 applies a voltage to pump electrodes 1021 and 1022 in accordance with the oxygen concentration so that an oxygen pump current agrees with a limit current with reference to a pre-obtained relationship between a voltage applied to an oxygen pump cell 1002 and a current flowing in the oxygen pump cell 1002. With this control, the oxygen concentration in each of a first measuring-object gas chamber 1011 and a second measuring-object gas chamber 1012 is maintained to a predetermined low value.

According to this control method, the oxygen concentration in the second measuring-object gas chamber 1012 tends to fluctuate. If the current flowing between sensor electrodes 1041 and 1042 of sensor cell 1004 is directly used as a sensor signal, the NOx detection accuracy will be worsened. Hence, this embodiment provides a current difference detection circuit 1459 which detects a difference between a current flowing between the sensor electrodes 1041 and 1042 of sensor cell 1004 and a current flowing between monitor electrodes 1031 and 1032 of oxygen monitor cell 1003. The obtained current difference is used as a sensor signal. Accordingly, the NOx concentration can be accurately obtained without being influenced by the variation of the oxygen concentration in the second measuring-object gas chamber 1012.

Like the above-described sixth embodiment, the pump electrode 1021 of this embodiment satisfies the above-described conditions explained with reference to any one of FIGS. 17, 19, 21, and 25-27.

Eight Embodiment

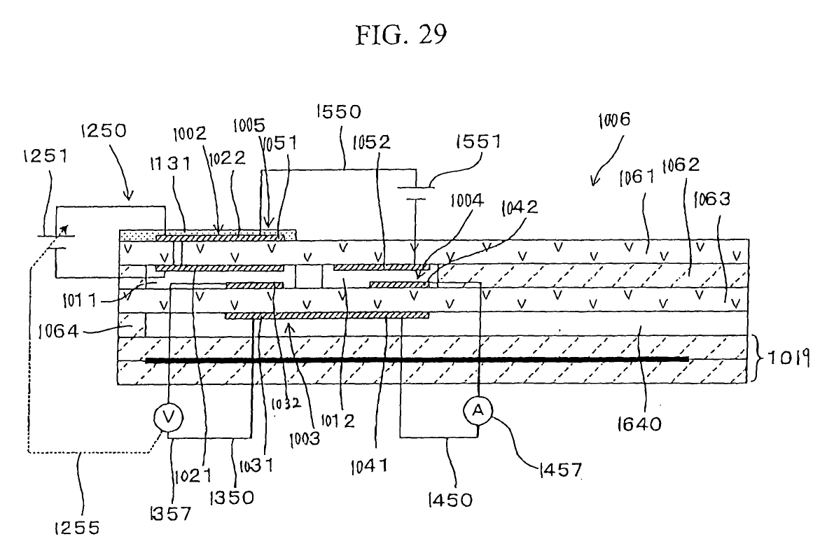

FIG. 29 shows a gas sensing element 1006 in accordance with another embodiment of the present invention, which is a 4-cell type element including two oxygen pump cells. The gas sensing element 1006 includes a spacer 1064 defining a reference gas chamber 1640, a solid electrolytic substrate 1063 on which an oxygen monitor cell 1003 and a sensor cell 1004, a spacer 1062 defining a first measuring-object gas chamber 1011 and a second measuring-object gas chamber 1012, a solid electrolytic substrate 1061 on which a first oxygen pump cell 1002 and a second oxygen pump cell 1005, which are stacked in this order on a heater 1019.

The first oxygen pump cell 1002 includes a pump electrode 1021 positioned in the first measuring-object gas chamber 1011 and a pump electrode 1022 covered by a porous protecting layer 1131. The pump electrode 1022 is exposed via the porous protecting layer 1131 to a measuring-object gas flowing outside the sensing element body. A first pump circuit 1250 including a power source 1251 is connected to the pump electrodes 1021 and 1022. The monitor cell 1003 includes a monitor electrode 1032 positioned in the first measuring-object gas chamber 1011 and a monitor electrode 1031 positioned in a reference gas chamber 1640. A monitor circuit 1350 including a voltmeter 1357 is connected to the monitor electrodes 1031 and 1032. The sensor cell 1004 includes a sensor electrode 1042 positioned in the second measuring-object gas chamber 1012 and a sensor electrode 1041 positioned in the reference gas chamber 1640. A sensor circuit 1450 including an ammeter 1457 is connected to the sensor electrodes 1041 and 1042. The monitor electrode 1031 and the sensor electrode 1041 are integrated as a single electrode. A control circuit 1255, interposed between the voltmeter 1357 and the power source 1251, controls the power source 1251 of oxygen pump cell 1002 based on a voltage value detected by the voltmeter 1357.

The second oxygen pump cell 1005 includes a pump electrode 1051 integrally formed with the pump electrode 1022 of first oxygen pump cell 1002 and a pump electrode 1052 positioned in the second measuring-object gas chamber 1012. A second pump circuit 1550 including a power source 1551 is connected to pump electrodes 1051 and 1052.

According to this embodiment, the oxygen concentration is detected based on an electromotive force produced between the monitor electrodes 1031 and 1032 of oxygen monitor cell 1003. The monitor electrode 1032 of oxygen monitor cell 1003 is positioned in the first measuring-object gas chamber 1011. The other monitor electrode 1031 is positioned in the reference gas chamber 1640 into which the air is introduced. According to the Nernst equation, an electromotive force is generated between the monitor electrodes 1031 and 1032 based on an oxygen concentration difference between the first measuring-object gas chamber 1011 and the reference gas chamber 1640.

As the oxygen concentration in the reference gas chamber 1640 is maintained at a constant value, the electromotive force generating between the monitor electrodes 1031 and 1032 reflects the oxygen concentration in the first measuring-object gas chamber 1011. Accordingly, the voltage applied between the pump electrodes 1021 and 1022 of oxygen pump cell 1002 is controlled in such a manner that the electromotive force generating between the monitor electrodes 1031 and 1032 becomes a constant value (e.g., 0.20 V). Through this control, the concentration of oxygen flowing into the second measuring-object gas chamber 1012 can be maintained at a constant value.

Furthermore, according to this embodiment, the second oxygen pump cell 1005 discharges the oxygen introduced into the second measuring-object gas chamber 1012 even if the first oxygen pump cell 1002 cannot sufficiently discharge the oxygen. Accordingly, the oxygen concentration in the second measuring-object gas chamber 1012 becomes 0. The sensor cell 1004 can accurately measure the NOx concentration.

Like the above-described sixth embodiment, the pump electrode 1021 of this embodiment satisfies the above-described conditions explained with reference to any one of FIGS. 17, 19, 21, and 25-27.

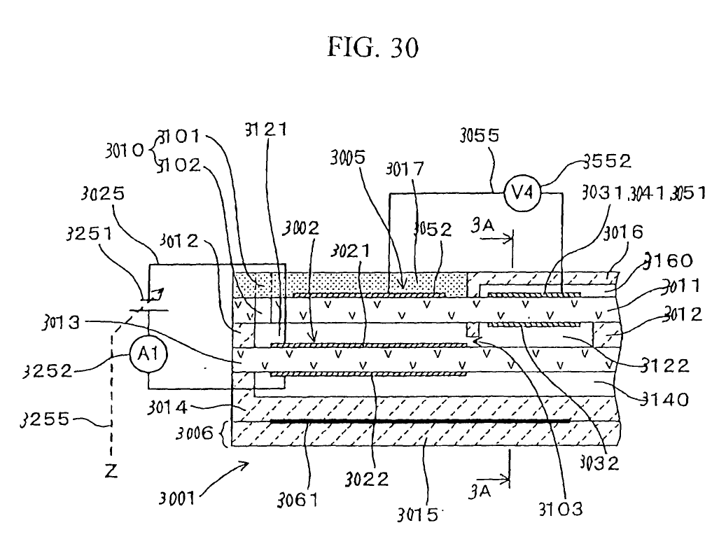

Next, another aspect of the present invention will be explained with reference to FIGS. 30 to 46.

According to this aspect of the present invention, the present invention provides a gas sensing element including a plurality of electrochemical cells, each including a solid electrolytic substrate and a pair of electrodes provided on the solid electrolytic substrate. A measuring-object gas is introduced into a measuring-object gas chamber. A spacer, laminated on the solid electrolytic substrate, defines the measuring-object gas chamber. A gas introducing passage introduces the measuring-object gas into the measuring-object gas chamber from an outside. At least one of the plurality of electrochemical cells is a pump cell for pumping oxygen from the measuring-object gas chamber to adjust an oxygen concentration in the measuring-object gas chamber. At least one of the plurality of electrochemical cells is a sensor cell for decomposing a specific gas in the measuring-object gas chamber to measure a specific gas concentration in the measuring-object gas chamber based on oxygen ions resulting from decomposed specific gas. The measuring gas chamber includes a plurality of cell chambers in which the electrochemical cells are provided, and a rate-determining diffusion passage connecting the cell chambers and allowing the measuring-object gas to flow between the cell chambers with a reduced flow rate.

According to one aspect of this gas sensing element, the gas introducing passage and the rate-determining diffusion passage satisfy the following relationship

(Sn/Ln)/(S0/L0)≦0.4

where L0 represents a longitudinal length of the gas introducing passage, S0 represents a transverse cross-sectional area of the gas introducing passage, Ln represents a longitudinal length of the rate-determining diffusion passage, and Sn represents a transverse cross-sectional area of the rate-determining diffusion passage.

According to another aspect of this gas sensing element, the pump cell and the sensor cell satisfy the following relationship when the oxygen concentration is 20%,

Is/Ip≦0.3

where Ip represents a pump limit current value flowing between the electrodes of the pump cell, and Is represents a sensor limit current value flowing between the electrodes of the sensor cell under a condition that the pump cell is not operating.

Furthermore, according to another aspect of this gas sensing element, the pump cell and the sensor cell satisfy the following relationship when the oxygen concentration is 20%,

Is/Sp≦0.06 mA/mm²

where Is represents a sensor limit current value flowing between the electrodes of the sensor cell under a condition that the pump cell is not operating, and Sp represents an area of the pump cell electrode positioned in the measuring-object gas chamber.

It is preferable that (Sn/Ln)/(S0/L0) is not greater than 0.04. In this case, the offset current becomes very small. When the gas sensing element is installed in the exhaust gas passage of an automotive engine, variability in the measuring accuracy of the specific gas can be suppressed within ±1% even when the engine driving conditions change greatly.

When installed at a downstream side of a catalytic converter in the exhaust gas passage of an automotive engine, the above-described gas sensing element can accurately monitor the deteriorated condition of a gas purifying catalyst because a great amount of air pollution substances are detectable at the downstream side of the catalyst in the event that the catalyst is deteriorated. Thus, the gas sensing element can be utilized for detecting the NOx concentration. Furthermore, the rich purge or refreshing treatment can be executed when any deterioration of the catalyst is detected, so as to maintain the purification rate at a higher level.

Furthermore, it is preferable that (Sn/Ln)/(S0/L0) is not smaller than 0.01. When (Sn/Ln)/(S0/L0) is smaller than 0.01, the measuring-object gas amount introduced into the measuring-object gas chamber becomes very small. The oxygen ion current flowing in the sensor cell becomes small. Accordingly, it becomes difficult to detect the oxygen ion current in the sensor cell. The measuring accuracy deteriorates.

In addition to the above-described pump cell and the sensor cell, the present invention is applicable to other electrochemical cells such as a monitor cell used for monitoring the oxygen concentration in the measuring-object gas chamber or an oxygen sensor cell used for measuring the oxygen concentration outside the sensor element. Furthermore, one of the electrochemical cells of the present invention is an air-fuel ratio cell detecting an air-fuel ratio or a λ sensor detecting a theoretical air-fuel ratio of the gas mixture introduced into an engine combustion chamber based on an oxygen concentration obtained from the oxygen sensor cell.

The oxygen sensor cell includes an electrode positioned in the measuring-object gas chamber and an electrode positioned in a reference gas chamber to measure an oxygen concentration based on an electromotive force produced between these electrodes or based on a limit current flowing in response to a voltage applied between two electrodes.

The gas introducing passage for introducing the measuring-object gas from the outside is a pinhole or a comparable through-hole which may be covered by a porous layer at its inlet side. In this case, the longitudinal length L0 is a shortest length of the pinhole including the porous layer. The area S0 is a transverse cross-sectional area of the gas introducing passage (i.e., pinhole or through-hole) normal to the longitudinal direction of the gas introducing passage. Furthermore, it is possible to fill at least part of the gas introducing passage with a porous member.

As described above, the measuring-object gas chamber includes the rate-determining diffusion passage connecting the cell chambers and allowing the measuring-object gas to flow between the cell chambers with a reduced flow rate. It may be possible to provide two cell chambers adjacently without forming a specific passage connecting them. The rate-determining diffusion passage can be constituted by an orifice narrower than the cell chamber. It is however possible to set a width of the rate-determining diffusion passage to be substantially identical with that of the cell chambers.

When the gas sensing element has a plurality of gas introducing passages, the longitudinal length L0 of the gas introducing passage is represented by the shortest length and the transverse cross-sectional area S0 of the gas introducing passage is represented by a sum of cross-sectional areas. The longitudinal length L0 of the gas introducing passage is measured as the shortest length of the gas flowing path connecting the center of its inlet opening and the center of its outlet opening. The transverse cross-sectional area S0 of the gas introducing passage is taken along a plane normal to the gas flowing path determining the longitudinal length L0 of the gas introducing passage.

The fundamental arrangement of the measuring-object gas chamber is constituted by two cell chambers connected via a rate-determining diffusion passage. Alternatively, the measuring-object gas chamber may include three cell chambers. The rate-determining diffusion passage may connect only two of these three cell chambers. It is possible to provide a plurality of rate-determining diffusion passages. For example, two rate-determining diffusion passages can be provided to connect three cell chambers. In this case, Sn/Ln is represented by the smallest value based on the comparison between dimensions of respective diffusion passages.

In addition to the solid electrolytic substrate of the electrochemical cell and the spacer for defining the measuring-object gas chamber, the gas sensing element includes a platelike ceramic heater for heating the gas sensing element up to a predetermined activation temperature. The specific gas measured by the above-described gas sensing element is, for example, NOx, CO and HC.

The pump cell is an electrochemical cell having the capability of pumping oxygen. In this respect, an electrochemical cell detecting the oxygen concentration in the measuring-object gas chamber can be regarded as the pump cell in this invention. More specifically, during detection of the oxygen concentration, ionized oxygen flows between the electrodes. This phenomenon can be utilized for pumping oxygen.

Preferably, a transverse width Wn of the rate-determining diffusion passage is not greater than 0.8 mm. With this arrangement, it becomes possible to decrease the offset current. If the transverse width Wn of the rate-determining diffusion passage is greater than 0.8 mm, the offset current will become large.

It is more preferable that the transverse width Wn of the rate-determining diffusion passage is not greater than 0.4 mm. In this case, the offset current becomes very small. When the gas sensing element is installed in the exhaust gas passage of an automotive engine, variability in the measuring accuracy of the specific gas can be suppressed within ±1% even when the engine driving conditions change greatly. Furthermore, it is preferable that the transverse width Wn of the rate-determining diffusion passage is not smaller than 0.1 mm. When the transverse width Wn is smaller than 0.1 mm, manufacturing the gas sensing element becomes difficult. The response of the gas sensing element will be worsened. When the gas sensing element has a plurality of rate-determining diffusion passages, it is preferable that each rate-determining diffusion passage satisfies the above-described conditions.

Preferably, the longitudinal length Ln of the rate-determining diffusion passage is not less than 0.4 mm. With this arrangement, the offset current becomes small. If the longitudinal length Ln is smaller than 0.4 mm, the offset current becomes so large that the measuring accuracy of the gas sensing element cannot be assured. Furthermore, it is more preferable that the longitudinal length Ln is not less than 0.6 mm.

Furthermore, it is preferable that the longitudinal length Ln of the rate-determining diffusion passage is not greater than 3 mm. If the longitudinal length Ln is greater than 3 mm, it will take a long time for the measuring-object gas to reach respective cell chambers. The response of the gas sensing element will be worsened. When the gas sensing element has a plurality of rate-determining diffusion passages, it is preferable that each rate-determining diffusion passage satisfies the above-described conditions.

Preferably, the pump cell is disposed in the cell chamber closest to the gas introducing passage and the sensor cell is disposed in the cell chamber farthest from the gas introducing passage, and the cell chambers satisfy v/V≦0.5, where v represents a volume of the sensor cell chamber and V represents a total volume of the plurality of cell chambers.

It is more preferable that v/V is not greater than 0.25. When the gas sensing element is installed in the exhaust gas passage of an automotive engine, variability in the measuring accuracy of the specific gas can be suppressed within ±1% even when the engine driving conditions change greatly. Furthermore, it is preferable that v/ is not smaller than 0.1. When v/V is smaller than 0.1, the output sensitivity is worsened.

Preferably, a thickness t of the cell chamber taken along a lamination direction of the gas sensing element is not greater than 0.16 mm. With this arrangement, the offset current becomes small. If the thickness t is larger than 0.16 mm, the offset current will become large.

It is more preferable that thickness t of the cell chamber is not greater than 0.1 mm. More excellent effects will be obtained when the thickness t is not greater than 0.05 mm. When the gas sensing element is installed in the exhaust gas passage of an automotive engine, variability in the measuring accuracy of the specific gas can be suppressed within ±1% even when the engine driving conditions change greatly. Furthermore, it is preferable that the thickness t of the cell chamber is not smaller than 0.01 mm. When the thickness t is smaller than 0.01 mm, the output current becomes very small. The sensor response will be worsened. When the gas sensing element has a plurality of cell chambers, the smallest thickness satisfies the above-described conditions.

Preferably, the total volume of the cell chambers is not greater than 4.1 mm³. With this arrangement, the offset current becomes small. If the total volume is greater than 4.1 mm³, the offset current will become large.

It is more preferable that the total volume of the cell chambers is not greater than 3.6 mm³. When the gas sensing element is installed in the exhaust gas passage of an automotive engine, variability in the measuring accuracy of the specific gas can be suppressed within ±1% even when the engine driving conditions change greatly. Furthermore, it is preferable that the total volume of the cell chambers is greater than 0.1 mm³. When the total volume is smaller than 0.1 mm³, the output current becomes very small.

Preferably, a porous member is disposed partly in at least one of the gas introducing passage, the cell chambers, and the rate-determining diffusion passage. With this arrangement, the offset current becomes small. In this case, it is preferably that a porosity of the porous member is 10% to 50%. With this arrangement, the offset current becomes small and the sensor response can be maintained at an appropriate level. When the porosity of the porous member is less than 10%, the measuring-object gas cannot diffuse smoothly and accordingly the sensor response will be worsened. Furthermore, when the porosity is larger than 50%, the effect of reducing the offset current is weakened. Preferably, the porous member contains alumina and/or zirconia.

Preferably, the pump electrode positioned in the pump cell chamber has a region whose surface temperature increases up to 800° C. when the gas sensing element is operating. As the pump cell has higher pumping ability at higher temperatures, the offset current can be effectively reduced by placing the pump electrode in a cell chamber having higher temperatures.

Ninth Embodiment

As shown in FIGS. 30 to 32B, a gas sensing element 3001 of this embodiment includes a plurality of electrochemical cells. A pair of electrodes 3031 and 3032 is provided on opposite surfaces of a solid electrolytic substrate 3011. Another pair of electrodes 3041 and 3042 is provided on the opposite surfaces of the solid electrolytic substrate 3011. A pair of electrodes 5051 and 5052 is provided at different portions on the same surface of the solid electrolytic substrate 3011. Another pair of electrodes 3021 and 3022 is provided on opposite surfaces of another solid electrolytic substrate 3013. A spacer 3012, interposing between the solid electrolytic substrates 3011 and 3013, defines a measuring-object gas chamber into which a measuring-object gas is introduced.

One of the electrochemical cells is a pump cell 3002 which pumps oxygen from the measuring-object gas chamber to adjust an oxygen concentration in the measuring-object gas chamber. Another one of the electrochemical cells is a sensor cell 3004 which decomposes NOx in the measuring-object gas chamber to measure a NOx concentration in the measuring-object gas chamber based on oxygen ions resulting from decomposed specific gas. A monitor cell 3003 and a λ cell 3005 are other electrochemical cells.

Furthermore, a gas introducing passage 3010 is provided to introduce the measuring-object gas into the measuring-object gas chamber from an outside. The measuring gas chamber includes a first cell chamber 3121 and a second cell chamber 3122 in which the electrochemical cells 3002, 3003 and 3004 are provided. A rate-determining diffusion passage 3103 connects two cell chambers 3121 and 3122 and allows the measuring-object gas to flow between these cell chambers 3121 and 3122 with a reduced flow rate.

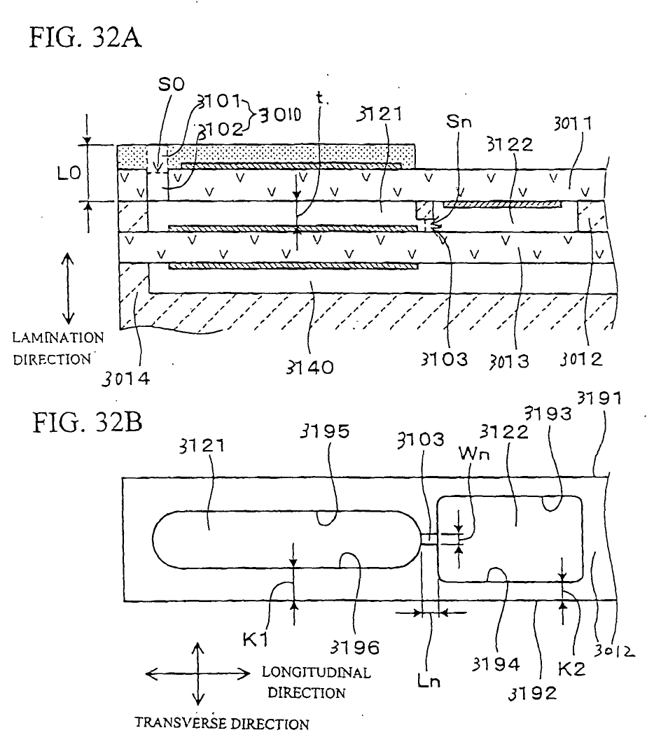

As shown in FIGS. 32A and 32B, the gas introducing passage 3010 and the rate-determining diffusion passage 3103 satisfy the following relationship

(Sn/Ln)/(S0/L0)≦0.4

where L0 represents a longitudinal length of the gas introducing passage 3010, S0 represents a transverse cross-sectional area of the gas introducing passage 3010, Ln represents a longitudinal length of the rate-determining diffusion passage 3103, and Sn represents a transverse cross-sectional area of the rate-determining diffusion passage 3103.

Hereinafter, the gas sensing element 3001 of this embodiment will be explained in more detail. The gas sensing element 3001 is incorporated into a gas sensor installed in an exhaust gas passage of an automotive engine to control combustion of the engine. The gas sensing element 3001 measures the NOx concentration or the oxygen concentration in the exhaust gas, or measures a ? point (i.e., theoretical air-fuel ratio point) of the engine.

The gas sensing element 3001 includes a first reference gas chamber 3140 and a second reference gas chamber 3160 in addition to the first cell chamber 3121 and the second cell chamber 3122. The pump cell 3002 pumps oxygen to or from the first cell chamber 3121. The monitor cell 3003 monitors the oxygen concentration in the second cell chamber 3122. The sensor cell 3004 detects the NOx concentration in the second cell chamber 3122. The ? cell 3005 detects the ? point of the engine based on the oxygen concentration in the measuring-object gas residing or flowing outside the gas sensing element 3001.

As shown in FIG. 30, the gas sensing element 3001 of this embodiment has a multilayered structure composed of a heater section 3006, a spacer 3014 defining the first reference gas chamber 3140, the solid electrolytic substrate 3013 constituting part of the pump cell 3002, a spacer 3012 defining the first and second cell chambers 3121 and 3122 connected via the rate-determining diffusion passage 3103 of the measuring-object gas chamber, the solid electrolytic substrate 3011 constituting part of the monitor cell 3003 and the sensor cell 3004, the spacer 3016 defining the second reference gas chamber 3160, and a porous layer 3017 which are stacked or laminated in this order. Exhaust gas is introduced into the first and second cell chambers 2121 and 2122 from the exhaust passage via the gas introducing passage 3010. Air is introduced into the first and second reference gas chambers 2140 and 2160.

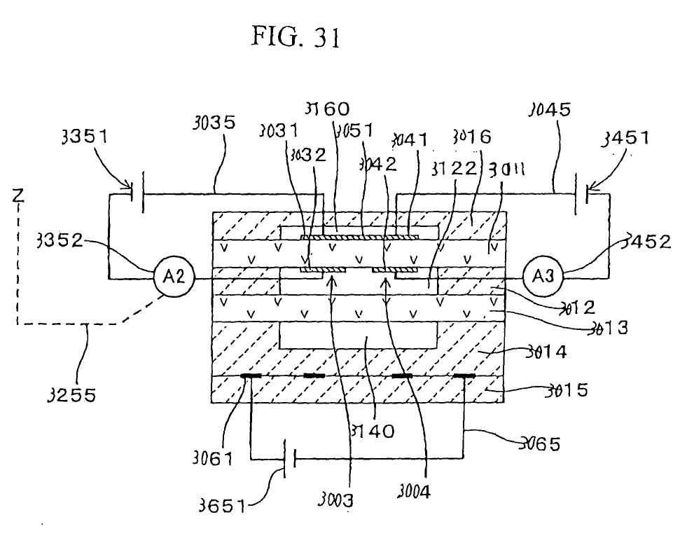

The first cell chamber 2121 is directly connected to the gas introducing passage 3010. The pump cell 3002 has an electrode positioned in the first cell chamber 2121. The second cell chamber 2122 is connected to the first cell chamber 2121 via the rate-determining diffusion passage 3103. The monitor cell 3003 and the sensor cell 3004 have electrodes positioned in the second cell chamber 2122. As understood from FIG. 31, the monitor cell 3003 and the sensor cell 3004 are aligned in the transverse direction of the gas sensing element 3001.

The first and second cell chambers 3121 and 3122 are defined in the laminated structure of the solid electrolytic substrates 3011 and 3013 and the spacer 3012. The porous layer 3017 closes an inlet opening of the gas introducing passage 3010 extending vertically across the solid electrolytic substrate 3011. The porous layer 3017 is located next to the spacer 3016 defining the second reference gas chamber 3160. Furthermore, the first reference gas chamber 3140 is defined in the laminated structure of the solid electrolytic substrate 3013, the spacer 3014, and the heater section 3006.

The heater section 3006 includes a heater substrate 3015 and a heat generating element 3061 provided on the heater substrate 3015. The solid electrolytic substrates 11 and 13 are made of zirconia ceramic. The heater substrate 3015, the spacers 3014, 3012, and 3016, and the porous layer 3017 are insulating members made of alumina ceramic.

As shown in FIGS. 30 and 31, the pump cell 3002 includes a first pump electrode 3021 provided on one surface of the solid electrolytic substrate 3013 so as to be positioned in the first cell chamber 3121 and a second pump electrode 3022 provided on the opposite surface of the solid electrolytic substrate 3013 so as to be positioned in the first reference gas chamber 3140. A pump circuit 3025 including a variable power source 3251 and an ammeter 3252 is connected between the first pump electrode 3021 and the second pump electrode 3022.

The monitor cell 3003 includes a first monitor electrode 3031 provided on one surface of the solid electrolytic substrate 3011 so as to be positioned in the second reference gas chamber 3160 and a second monitor electrode 3032 provided on the opposite surface of the solid electrolytic substrate 3011 so as to be positioned in the second cell chamber 3122. A monitor circuit 3035 including a power source 3351 and an ammeter 3352 is connected between the first monitor electrode 3031 and the second monitor electrode 3032. A feedback circuit 3255 is provided to feedback control the power source 3251 in the pump circuit 3025 based on the current signal detected by the ammeter 3352 in the monitor circuit 3035.

The sensor cell 3004 includes a first sensor electrode 3041 provided on one surface of the solid electrolytic substrate 3011 so as to be positioned in the second reference gas chamber 3160 and a second sensor electrode 3042 provided on the opposite surface of the solid electrolytic substrate 3011 so as to be positioned in the second cell chamber 3122. A sensor circuit 3045 including a power source 3451 and an ammeter 3452 is connected between the first sensor electrode 3041 and the second sensor electrode 3042.

As shown in FIG. 30, the λ cell 3005 includes a first λ electrode 3051 and a λ second electrode 3052 provided on the same surface of the solid electrolytic substrate 3011. The first λ electrode 3051 is positioned in the second reference gas chamber 3160. The second λ electrode 3052 is interposed between the solid electrolytic substrate 3011 and the porous layer 3017 so as to be exposed to the measuring-object gas residing or flowing outside the element body. A λ cell circuit 3055 including a voltmeter 3552 is connected between the first λ electrode 3051 and the second λ electrode 3052. Furthermore, the heat generating element 3061 of the heater section 3006 is connected to a heater leads and terminals. The electrodes 3031, 3041 and 3051 of the monitor cell 3003, the sensor cell 3005, and the λ cell 3005 are integrally formed as a common electrode.

Furthermore, as shown in FIGS. 30 and 32A, the gas introducing passage 3010 includes a pinhole 3102 extending across the solid electrolytic substrate 3011 in the lamination direction of the sensing element. An inlet opening of the pinhole 3102 is covered by a porous layer 3101. The longitudinal length L0 of the gas introducing passage 3010 is the shortest length of a gas flowing path ranging from the porous layer 3101 and the pinhole 3102. The cross-sectional area S0 of the gas introducing passage 3010 is determined by a cross-sectional area of the pinhole 3102 taken along a plane normal to the longitudinal direction of the pinhole 3102. According to the gas introducing passage 3010 shown in FIGS. 32A and 32B, the longitudinal length L0 is 0.28 mm and the cross-sectional area S0 is 0.13 mm². Regarding the rate-determining diffusion passage 3103, its longitudinal length Ln is 1.6 mm and the cross-sectional area Sn is 0.04 mm². Accordingly, (Sn/Ln)/(S0/L0) is 0.05 and accordingly fairly smaller than 0.4.

The transverse width Wn of the rate-determining diffusion passage 3103, measured along a direction normal to the longitudinal direction of the gas sensing element 3001, is 0.32 mm and accordingly not greater than 0.8 mm. A voltage v of the second cell chamber 3122 is 0.94 mm³. The first cell chamber 3121 has a volume of 1.54 mm³. A total volume V of the cell chambers is 2.48 mm³. Accordingly, v/V is 0.38 and accordingly smaller than 0.5.

Furthermore, the thickness t of respective cell chambers 3121 and 3122 along the lamination direction is expressed by a clearance between the electrode 3021 and the solid electrolytic substrate 3011 or a clearance between the solid electrolytic substrate 3013 and the electrode 32 or 42. The thickness t is represented by a shorter clearance, in the case that the above two clearances are different from each other. According to the gas sensing element 3001 of this embodiment, the thickness t is 0.12 mm and accordingly shorter than 0.16 mm. Furthermore, the total volume V of the cell chambers 3121 and 3122 is 2.48 mm³ and accordingly smaller than 4.1 mm³.

Furthermore, in FIG. 32B, K1 represents a smallest distance between an outer side surface 3191 or 3192 of the spacer 3012 and an inner side surface 3195 or 3196 of the first cell chamber 3121 and K2 represents a smallest distance between the outer side surface 3191 or 3192 of the spacer 3012 and an inner side surface 3193 or 3194 of the second cell chamber 3122. It is preferable that K1 and K2 are not smaller than 0.5 mm to prevent the measuring-object gas from leaking out of the first and second cell chambers 3121 and 3122 via the side surface of the element 3001. It is more preferable that K1 and K2 are not smaller than 0.8 mm.

The gas sensing element 3001 of this embodiment is manufactured in the following manner.

A plurality of green sheets for the heater substrate 3015, spacer 3014, solid electrolytic substrate 3013, solid electrolytic substrate 3011, and porous layer 3017 are prepared. A paste containing electric conductive material is applied on the heater substrate .3015 to form a print pattern of the heat generating element. A paste containing electric conductive material is applied on the solid electric substrate 3013 to form a print pattern of respective electrodes. A paste containing ceramic material is applied to a portion becoming the spacer 3012. Furthermore, A paste containing electric conductive material is applied on the solid electric substrate 3011 to form a print pattern of respective electrodes. A paste containing ceramic material is applied to a portion becoming the spacer 3016.

The gas sensing element 3001 of this embodiment satisfies the relationship

(Sn/Ln)/(S0/L0)≦0.4

where L0 represents the longitudinal length of the gas introducing passage 3010, S0 represents the transverse cross-sectional area of the gas introducing passage 3010, Ln represents the longitudinal length of the rate-determining diffusion passage 3103, and Sn represents the transverse cross-sectional area of the rate-determining diffusion passage 3103.

Accordingly, the pump cell 3002 can sufficiently discharge the oxygen from the first cell chamber 3121 before the oxygen diffuses into the second cell chamber 3122 where the sensor cell 3004 for detecting the NOx concentration is provided. Hence, the oxygen concentration in the measuring-object gas chamber becomes small and stable. As a result, the offset current becomes very small. The gas sensing element 3001 can accurately measure the NOx concentration.

The gas sensing element 3001 of this embodiment was evaluated in the following manner.

A plurality kinds of gas sensing element samples differentiated in the value of (Sn/Ln)/(S0/L0) were prepared to measure the offset current (i.e., a current flowing in the sensor cell when no NO is contained in the measuring-object gas). The offset current is measured by the ammeter 3452 shown in FIG. 31.

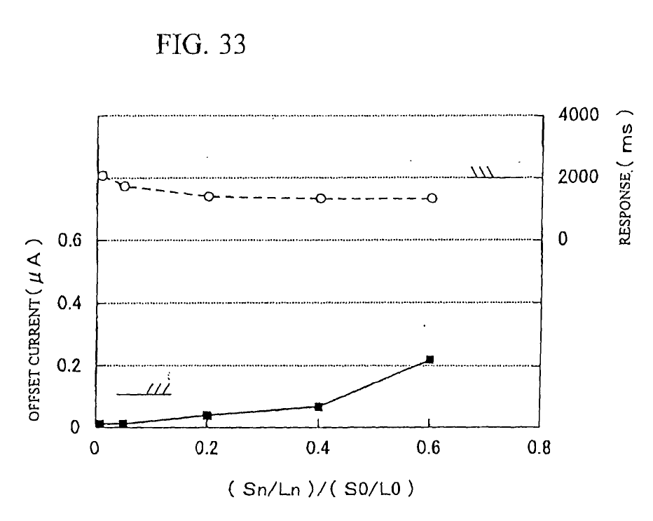

Similarly, a plurality kinds of gas sensing element samples differentiated in the value of (Sn/Ln)/(S0/L0) were prepared to measure the sensor current when these samples were exposed to a measuring-object gas having the NO concentration switched from 300 ppm to 100 ppm. The sensor current was measured by the ammeter 3452. In this evaluation test, the NO concentration was switched at the time T0. Prior to the time T0, the ammeter 3452 measure the current I0 under the condition that the NO concentration was 300 ppm. After passing the time T0, the sensor current reached 0.6 I0 (i.e., a 60% level of I0) at the time T1. A difference T1−T0 was measured. When T1−T0 is small, the gas sensing element becomes quick in response. FIG. 33 is the evaluation result showing the offset current and the response (i.e., T1−T0) measured in relation with (Sn/Ln)/(S0/L0).

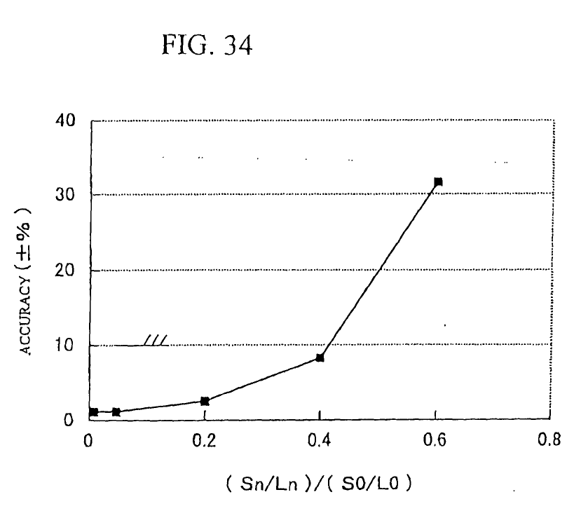

As shown in FIG. 33, the offset current exceeds 0.1 μA when (Sn/Ln)/(S0/L0) is larger than 0.4. The offset current increases with increasing (Sn/Ln)/(S0/L0). Regarding the samples having the offset current exceeding 0.1 μA, the accuracy exceeds ±10% when the oxygen concentration is switched (refer to FIG. 34). When (Sn/Ln)/(S0/L0) exceeds 0.2, the response becomes smaller than 2,000 ms. However, the response does not show substantial change in accordance with further increase of (Sn/Ln)/(S0/L0). Accordingly, setting (Sn/Ln)/(S0/L0) to be not greater than 0.4 is effective in improving the measuring accuracy and makes it possible to obtain a gas sensing element possessing quick response.

Furthermore, a plurality kinds of gas sensing element samples differentiated in the value of (Sn/Ln)/(S0/L0) were prepared. While the NO concentration in the measuring-object gas was maintained at a constant value (0 ppm), the oxygen concentration was shifted from 0% to 20%. The current flowing in the sensor cell was measured by the ammeter 3452 shown in FIG. 31. The change rate of the current value was obtained as a ratio of current values measured before and after the switching of oxygen concentration from 0% to 20%. Furthermore, NO sensitivity was defined by subtracting a current value corresponding to the NO concentration of 100 ppm by a current value corresponding to the NO concentration of 0 ppm from, under the condition that the oxygen concentration is 0%. A ratio of the above change amount with respect to the NO sensitivity was defined as a change rate. In an ideal case, the current value of ammeter 3452 does not change and accordingly the change rate becomes 0. However, in practical cases, oxygen ions resulting from decomposed oxygen contribute the sensor current and accordingly the change rate is not 0. From this fact, the above-defined change rate was adopted as a factor representing the accuracy. FIG. 34 shows the accuracy in relation to (Sn/Ln)/(S0/L0).

As shown in FIG. 34, when (Sn/Ln)/(S0/L0) exceeds 0.4, the sensor current increases greatly with increasing oxygen concentration and exceeds 10%. Namely, satisfying (Sn/Ln)/(S0/L0)≦0.4 makes it possible to obtain the sensor current without being adversely influenced by the oxygen concentration. Thus, it becomes possible to obtain a gas sensing element possessing excellent measuring accuracy. If the accuracy of the gas sensing element exceeds 10%, there will be the possibility that deterioration of the catalyst is erroneously detected. On the other hand, if the response exceeds 2 seconds, it will be difficult to perform real time measurement applicable to actual variations of the specific gas concentration occurring in the exhaust gas emitted from a traveling automotive vehicle.

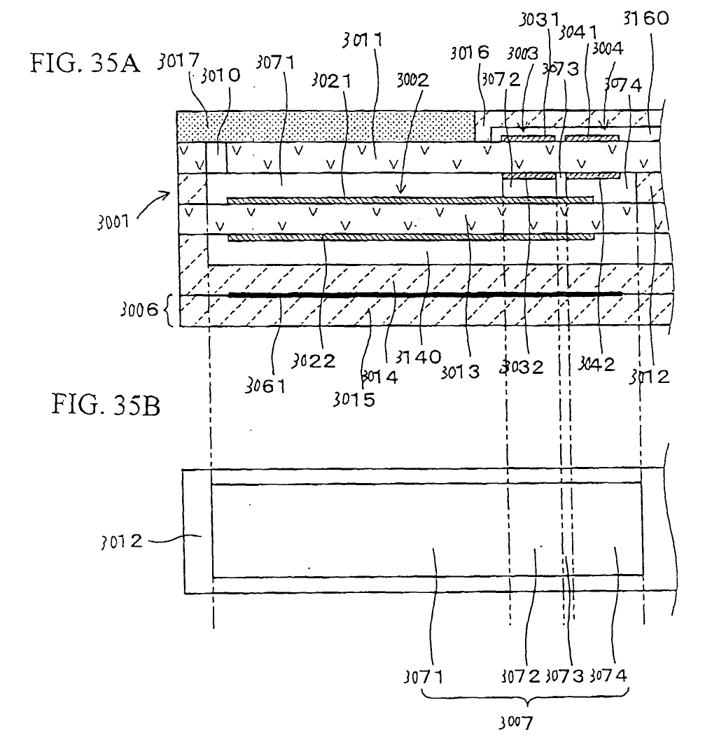

FIGS. 35A and 35B show a gas sensing element 3001 having a modified measuring gas chamber 3007. As shown in FIG. 35A, the measuring gas chamber 3007 is defined in the laminated structure of the solid electrolytic substrate 3011, the solid electrolytic substrate 3013, and the spacer 3012. The porous layer 3017 covering the gas introducing passage 3010 is provided next to the spacer 3016 defining the second reference gas chamber 3160. The first reference gas chamber 3140 is defined in the laminated structure of the solid electrolytic substrate 3013, the spacer 3014, and the heater section 3006.

The measuring gas chamber 3007 consists of a first cell chamber 3071, a second cell chamber 3072, and a third cell chamber 3074. The second cell chamber 3072 and the third cell chamber 3074 are directly connected via a rate-determining diffusion passage 3073. The pump cell 3002 includes a pair of electrodes 3021 and 3022 provided on the surfaces of the solid electrolytic substrate 3013. The electrodes 3021 and 3022 extend in the longitudinal direction from the first cell chamber 3071 to the third cell chamber 3074. The monitor cell 3003 is positioned in the second cell chamber 3072. The sensor cell 3004 is positioned in the third cell chamber 3074. The rate-determining diffusion passage 3073 has the same transverse width as those of the first, second, and third cell chambers 3071, 3072, and 3074.

According to the introducing passage 3010 shown in FIG. 35A, the longitudinal length L0 is 0.28 mm and the cross-sectional area S0 is 0.126 mm². Regarding the rate-determining diffusion passage 3073, its longitudinal length Ln is 1.6 mm and the cross-sectional area Sn is 0.038 mm². Accordingly, (Sn/Ln)/(S0/L0) is 0.05 and accordingly fairly smaller than 0.4. The rest of the arrangement is similar to that of the above-described embodiment and brings substantially the same effects.

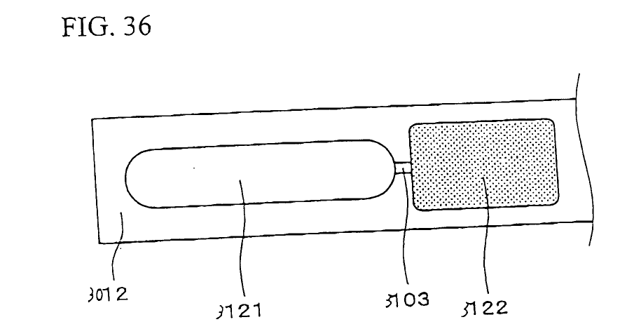

FIG. 36 shows a gas sensing element having the second cell chamber 3122 filled with a porous material. The porous material is made of alumina ceramic having the same composition as that of spacer 3012. The porosity of this porous material is 25%. The rest of the arrangement is similar to that of the above-described embodiment and brings substantially the same effects.

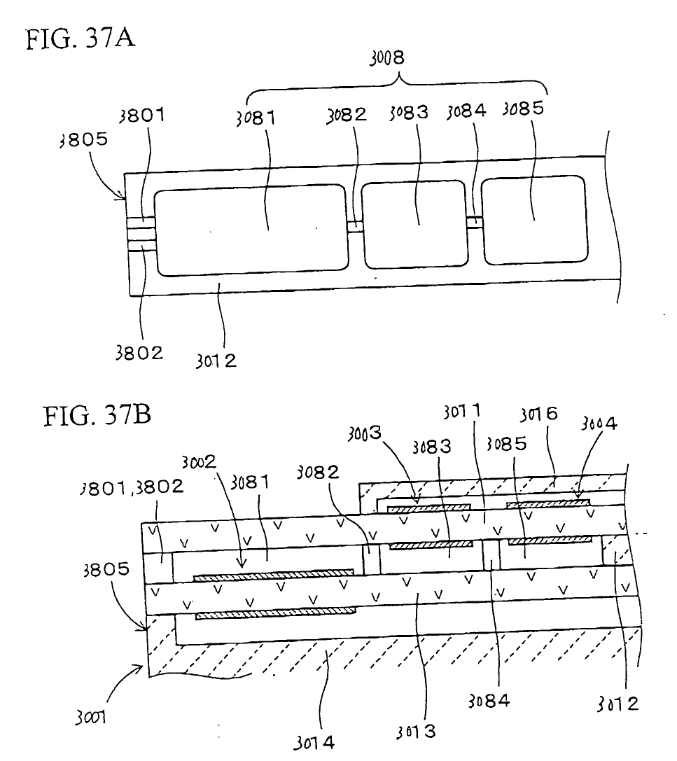

FIGS. 37A and 37B show a gas sensing element 3001 having three cell chambers 3081, 3083, and 3085 cooperatively constituting a measuring-object gas chamber 3008. The first cell chamber 3081 and the second cell chamber 3083 are connected via a rate-determining diffusion passage 3082. The second cell chamber 3083 and the third cell chamber 3085 are connected via a rate-determining diffusion passage 3084. Two gas introducing passages 3081 and 3082, provided at a front end 3805 of the spacer 3012, directly connect the first cell chamber 3081 to the outside of the element body. As show in FIG. 37B, the measuring-object gas chamber 3008 is defined in the laminated structure of the solid electrolytic substrate 3011, the solid electrolytic substrate 3013, and the spacer 3012. The spacer 3016, defining the second reference gas chamber 3160, is disposed on the solid electrolytic substrate 3011. Furthermore, the first reference gas chamber 3140 is defined in the laminated structure of the solid electrolytic substrate 3013, the spacer 3014, and the heater section 3006.

The measuring-object gas chamber 3008 consists of the first cell chamber 3081, the rate-determining diffusion passage 3082, the second cell chamber 3082, the rate-determining diffusion passage 3084, and the third cell chamber 3085 sequentially arranged in this order in the longitudinal direction of the sensor element 3001. The pump cell 3002 is positioned in the first cell chamber 3081. The monitor cell 3003 is positioned in the second cell chamber 3083. The sensor cell 3004 is positioned in the third cell chamber 3085. The spacer measuring-object gas is introduced into the first cell chamber 3081 from the gas introducing passages 3801 and 3802 opened at the front end 3805 of the gas sensing element 3001.

The introducing passages 3801 and 3802 are identical with each other in that the longitudinal length L0 is 0.28 mm. A total cross-sectional area S0 of the introducing passages 3801 and 3802 is 0.13 mm. The rate-determining diffusion passages 3082 and 3084 are identical with each other in that the longitudinal length is 0.8 mm (i.e., Ln=1.6 mm) and the cross-sectional area Sn is 0.038 mm². Accordingly, (Sn/Ln)/(S0/L0) is 0.05 and accordingly fairly smaller than 0.4. The rest of the arrangement is similar to that of the above-described embodiment and brings substantially the same effects.

Tenth Embodiment

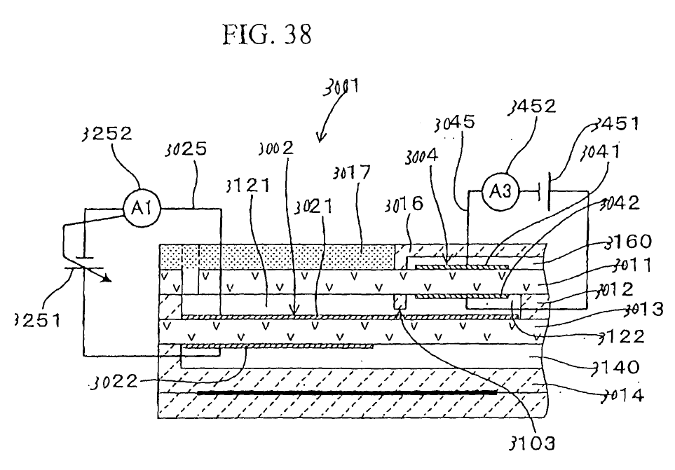

As shown in FIGS. 38 to 41, a gas sensing element 3001 of this embodiment includes the pump cell 3002, the monitor cell 3003, and the sensor cell 3004. The first pump electrode 3021 of the pump cell 3002 extends in the longitudinal direction from the first cell chamber 3121 to the second cell chamber 3122 via the rate-determining diffusion passage 3103. The first pump electrode 3021 has an area of 20 mm². The second pump cell 3022 is positioned in the first reference gas chamber 3140. As shown in FIG. 41, the second pump cell 3022 can be formed to be smaller in area than the first cell chamber 3121. Giving a large area of 20 mm² to the first pump electrode 3021 is advantageous in effectively discharging oxygen out of the measuring-object gas chamber.

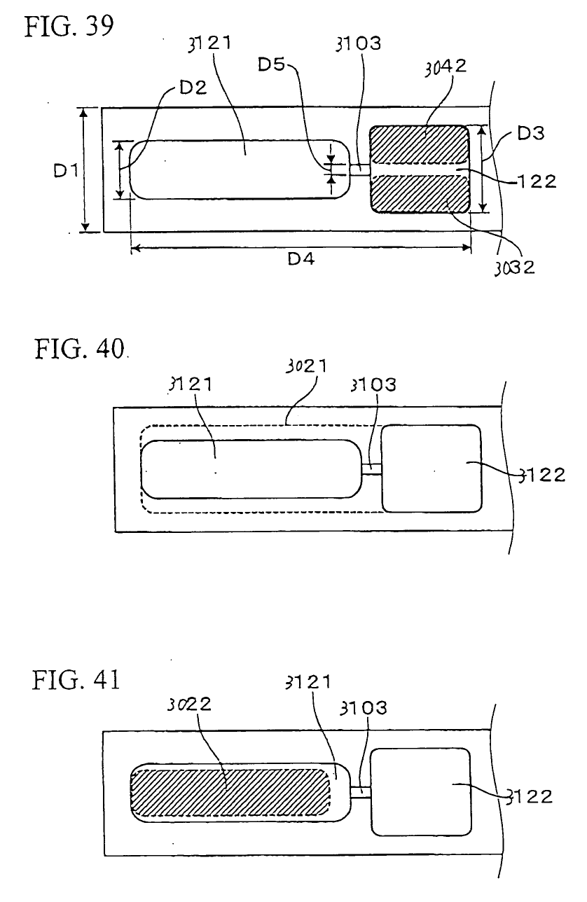

The pump cell 3002 is connected to the pump circuit 3025 including the variable power source 3251 and the ammeter 3252. A voltage applied to the pump cell 3002 from the variable power source 3251 is feedback controlled based on a pump current value, i.e., a current value measured by the ammeter 3252, so that a constant current flows in the ammeter 3252. As shown in FIG. 39, the second monitor electrode 3032 of the monitor cell 3003 is positioned in the second cell chamber 3122. The second sensor electrode 3042 of the sensor cell 3004 is also positioned in the second cell chamber 3122. The second monitor electrode 3032 and the second sensor electrode 3042 have the same area of 3.6 mm². The first cell chamber 3121, the rate-determining diffusion passage 3103, and the second cell chamber 3122 are specified by the dimensions D1 to D5, in which D1=5 mm, D2=1.6 mm, D3=2.7 mm, D4=14 mm, and D5=0.24 mm.

The pump limit current Ip flows between the electrodes 3021 and 3022 of the pump cell 3002. The sensor current Is flows between the electrodes 3041 and 3042 of the sensor cell 3004 under the condition that the pump cell 3002 is not operating. The pump limit current Ip, the sensor current Is, and the offset current of the above-described gas sensing element 3001 were measured in the following manner.

A gas sensing element sample was prepared and subjected to a nitrogen-diluted gas mixture having the oxygen concentration of 20%. The air having the oxygen concentration of 21% was introduced into the first reference gas chamber 3140 and the second reference gas chamber 3160. Under the condition that the variable power source 3251 of the pump circuit 3025 was turned off, the sensor current Is was measured by the ammeter 3452 in the sensor circuit 3045. When 0.45 V was supplied from the variable power source 3251, the pump limit current Ip was measured by the ammeter 3252.

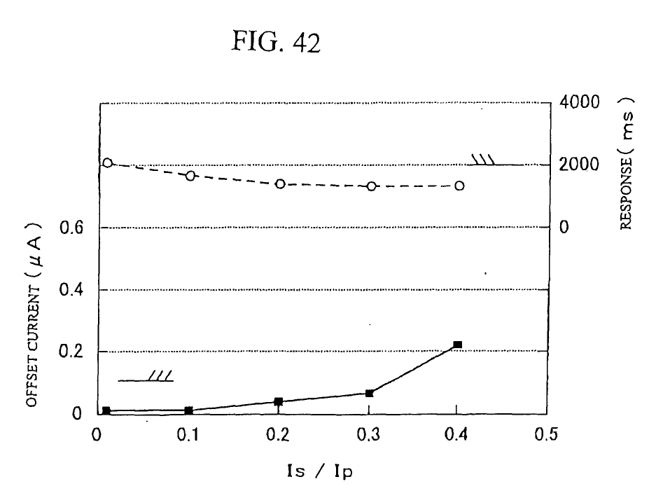

Similarly, the same gas sensing element sample was subjected to a nitrogen-diluted gas mixture having the oxygen concentration of 0% to 20% and containing no NOx. Under the condition that 0V to 0.45V was supplied from the variable power source 3251, the offset current was measured from the current value of the ammeter 3452 at the timing the ammeter 3252 showed the pump cell limit current corresponding to each oxygen concentration. This measurement was repetitively performed for several samples of the gas sensing element 3001 which are differentiated in the width D5 of the rate-determining diffusion passage 3103. FIG. 42 shows the measurement result. As apparent from FIG. 42, the offset current can be suppressed within 0.1 μA when Is/Ip is not greater than 0.3.

Furthermore, the response of the gas sensing element was evaluated in the same manner. As a result, the response was 2,000 ms even when Is/Ip was very small. Thus, it is confirmed that satisfying Is/Ip≦0.3 is effective to decrease the offset current and improve the response of the sensing element.

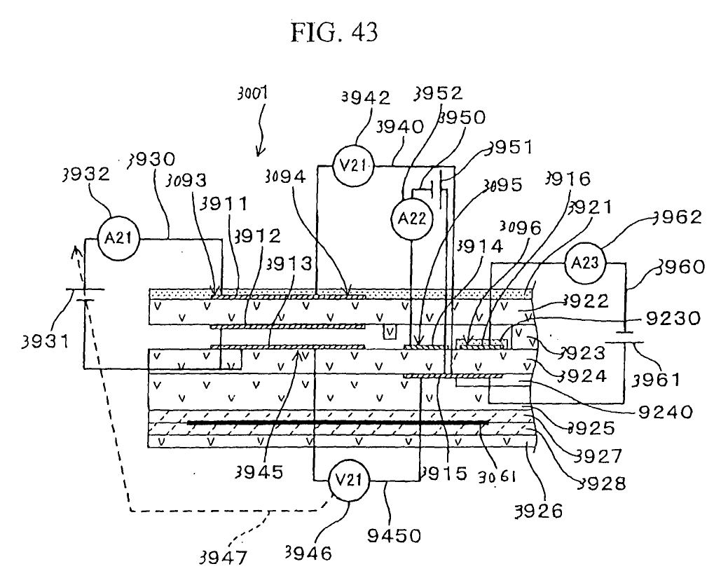

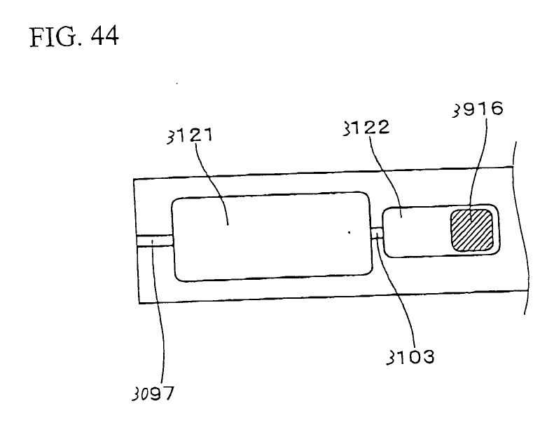

FIGS. 43 and 44 show a gas sensing element 3001 having a total of five electrochemical cells. As shown in FIG. 43, the gas sensing element 3001 has a multilayered structure composed of a porous layer 3921, a solid electrolytic substrate 3922, a spacer 3923, a solid electrolytic substrate 3924, a spacer 3925, two alumina insulation plates 3927 and 3928, and a substrate 3926. A heat generating element 3061 is interposed between two alumina insulation plates 3927 and 3928.

A gas introducing passage 3097, a first cell chamber 3121, a rate-determining diffusion passage 3103, and a second cell chamber 3122 are successively formed in the spacer 3923 interposed between the solid electrolytic substrate 3922 and the solid electrolytic substrate 3924. A reference gas chamber 9240 is formed between the solid electrolytic substrate 3924 and the spacer 2925. An electrode 3911 is disposed between the solid electrolytic substrate 3922 and the porous layer 3921. An electrode 3912 is provided on a surface of the solid electrolytic substrate 3922 so as to be positioned in the first cell chamber 3121. An electrode 3913 is provided on a surface of the solid electrolytic substrate 3924 so as to be positioned in the first cell chamber 3121.

Two electrodes 3914 and 3916 are provided on the surface of the solid electrolytic substrate 3924 so as to be positioned in the second cell chamber 3122. The surface of electrode 3916 is covered by a porous layer 9230. Furthermore, compared with the electrode 3916, the electrode 3914 is positioned closer to the rate-determining diffusion passage 3103. The electrode 3915 is interposed between the solid electrolytic substrate 3924 and the spacer 3925. The electrode 3915 is partly positioned in the reference gas chamber 9240.

Five electrochemical cells of the gas sensing element 3001 are a pump cell 3093, a λ cell 3094, a monitor cell 3945, a sub pump cell 3095, and a sensor cell 3096. The pump cell 3093 is composed of the electrodes 3911, 3912, 3913 and the solid electrolytic substrate 3922 for discharging oxygen out of the first cell chamber 3121. The pup cell 3093 is connected to a pump circuit 3930 including a variable power source 3931 and an ammeter 3932. The λ cell 3094 detects a λ point based on measurement of the oxygen concentration in the measuring-object gas. The λ cell 3094 is an electromotive type cell composed of the electrodes 3911 and 3915 and the solid electrolytic substrates 3922 and 3924. The electrode 3915 serves as a reference electrode of the λ cell 3094. The λ cell 3094 is connected to a λ circuit 3940 including a voltmeter 3942.

The monitor cell 3945 monitors the oxygen concentration in the first cell chamber 3121 to control the operation of pump cell 3093. The monitor cell 3945 is an electromotive type cell composed of the electrodes 3913 and 3915 and the solid electrolytic substrate 3924. The electrode 3915 serves as a reference electrode of the monitor cell 3945. The monitor cell 3945 is connected to a monitor circuit 9450 including a voltmeter 3946. A control circuit 3947 is provided to control the variable power source 3931 of the pump circuit 3930 based on an output of the voltmeter 3946. The sub pump cell 3095 is composed of the electrodes 3914 and 3915 and the solid electrolytic substrate 3924 for discharging oxygen out of the second cell chamber 3122. The sub pump cell 3095 is connected to a sub pump circuit 3950 including a power source 3951 and an ammeter 3952.

The sensor cell 3096 is composed of the electrodes 3916 and 3915 and the solid electrolytic substrate 3924 for measuring the concentration of a specific gas (e.g., NOx) in the second cell chamber 3122. The sensor cell 3096 is different from the sub pump cell 3095 in that the electrode 3915 of the sensor cell 3096 is positioned in the reference gas chamber 9240 and the surface of electrode 3916 is not directly exposed to the second cell chamber 3122. The electrode 3916 is covered by the porous layer 9230 and accordingly indirectly exposed to the second cell chamber 3122. The sensor cell 3096 is connected to a sensor circuit 3960 including a power source 3961 and an ammeter 3962.

The gas sensing element 3001 shown in FIGS. 43 and 44 satisfies the relationship Is/Ip≦0.3, where Ip represents the pump limit current flowing in the pump cell 3093 and the sub pump cell 3095 and Is represents the sensor current flowing in the sensor cell 3096 under the condition that the pump cell 3093 and the sub pump cell 3095 are not operating. Thus, the offset current becomes small and the measuring accuracy of the sensing element is improved.

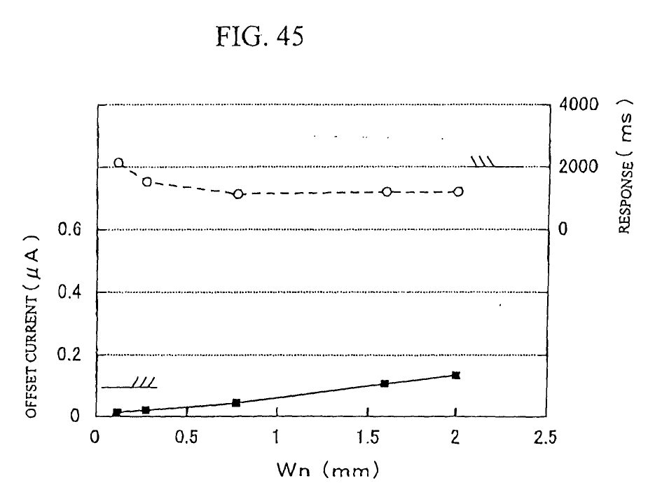

To evaluate the offset current and the response, a plurality kinds of gas sensing element samples differentiated in the transverse width Wn of the rate-determining diffusion passage were prepared. FIG. 45 shows an evaluation result of the offset current and the response in relation to the transverse width Wn of the rate-determining diffusion passage. From FIG. 45, it is understood that satisfying Wn≦0.8 mm is effective to decrease the offset current and improve the response of the sensing element.

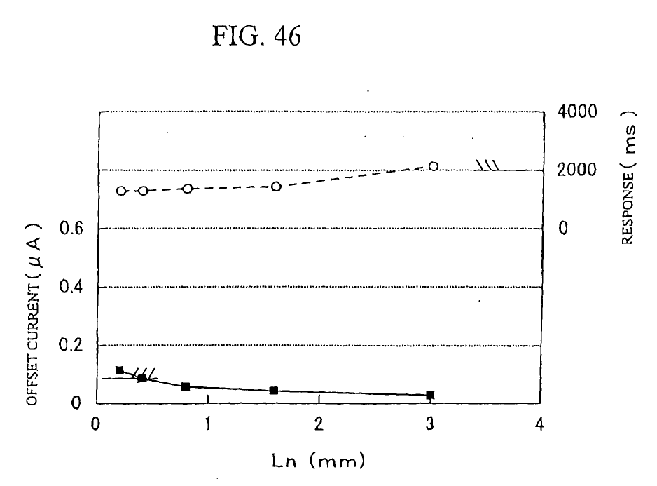

Furthermore, a plurality kinds of gas sensing element samples differentiated in the longitudinal length Ln of the rate-determining diffusion passage were prepared. FIG. 46 shows an evaluation result of the offset current and the response in relation to the longitudinal length Ln of the rate-determining diffusion passage. From FIG. 46, it is understood that satisfying Ln≧0.4 mm is effective to decrease the offset current and improve the response of the sensing element.

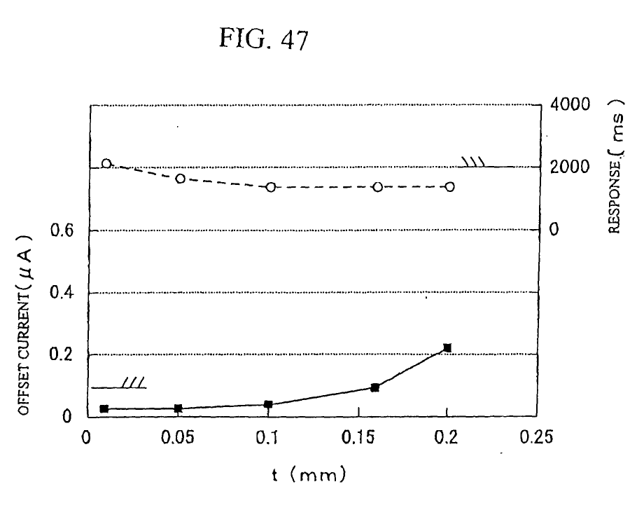

Furthermore, a plurality kinds of gas sensing element samples differentiated in the vertical thickness t of the cell chambers were prepared. FIG. 47 shows an evaluation result of the offset current and the response in relation to the vertical thickness t of the cell chambers. From FIG. 47, it is understood that satisfying t≦0.4 mm is effective to decrease the offset current and improve the response of the sensing element.

What is claimed is:

1. A gas sensing element comprising:
a measuring-object gas chamber into which a measuring-object gas to be measured is introduced from the outside;
a reference gas chamber into which a reference gas is introduced;
a pump cell for pumping oxygen into or from said measuring-object gas chamber; and
a sensor cell for measuring a concentration of a specific gas contained in said measuring-object gas,
wherein said pump cell comprising a solid electrolytic substrate, a first pump electrode provided on a surface of said solid electrolytic substrate so as to be exposed to said measuring-object gas stored in said measuring-object gas chamber, and a second pump electrode provided on an opposite surface of said solid electrolytic substrate,
said sensor cell comprising a solid electrolytic substrate, a first sensor electrode provided on a surface of said solid electrolytic substrate so as to be exposed to said measuring-object gas stored in said measuring-object gas chamber, and a second sensor electrode provided on another surface of said solid electrolytic substrate so as to be exposed to said reference gas stored in said reference gas chamber, and
said first pump electrode has an upstream portion positioned at an upstream side of said first sensor electrode in a flow direction of said measuring-object gas, and said upstream portion of said first pump electrode satisfies the following relationship
2.0≦c/a≦7.0
where ‘c’ represents a maximum length of said upstream portion of said first pump electrode in a longitudinal direction of said gas sensing element, and ‘a’ represents a maximum width of said upstream portion of said first pump electrode in a transverse direction of said gas sensing element.

2. The gas sensing element in accordance with claim 1, wherein said pump cell and said sensor cell further satisfy the following relationship
2≦Sp/Ss≦30
where ‘Sp’ represents an area of said upstream portion of said first pump electrode positioned at the upstream side of said first sensor electrode while ‘Ss’ represents an area of said first sensor electrode of said sensor cell.

3. The gas sensing element in accordance with claim 1, wherein said first pump electrode of the pump cell contains Pt—Au.

4. The gas sensing element in accordance with claim 3, wherein Au content in said Pt—Au is in a range from 1 wt % to 5 wt %.

5. A multilayered gas sensing element comprising
a measuring-object gas chamber into which a measuring-object gas is introduced under a predetermined diffusion resistance;
an oxygen pump cell having a pair of pump electrodes provided on surfaces of an oxygen ion conductive solid electrolytic substrate, with one of said pump electrodes being positioned in said measuring-object gas chamber, for pumping oxygen into or from said measuring-object gas chamber in response to electric power supplied to said pump electrodes to adjust an oxygen concentration in said measuring-object gas chamber; and
a sensor cell having a pair of sensor electrodes provided on surfaces of an oxygen ion conductive solid electrolytic substrate, with one of said sensor electrodes being positioned in said measuring-object gas chamber, for detecting a specific gas concentration in said measuring-object gas chamber based on an oxygen ion current produced between said sensor electrodes,
wherein said one of the pump electrodes of the oxygen pump cell positioned in said measuring-object gas chamber has a side surface extending in a longitudinal direction of said gas sensing element and facing via a clearance region to an inside surface of said measuring-object gas chamber, and
a minimum value of a total width G of said clearance region in a transverse direction of said gas sensing element is not greater than 0.5 mm.

6. The multilayered gas sensing element in accordance with claim 5, wherein the longitudinal length of the portion of said pump electrode where said clearance region has the total width not greater than 0.5 mm is not shorter than ¼ of an entire longitudinal length of said pump electrode positioned in said measuring-object gas chamber.

7. The multilayered gas sensing element in accordance with claim 5, further comprising an oxygen monitor cell having a pair of monitor electrodes provided on surfaces of an oxygen ion conductive solid electrolytic substrate, with one of said monitor electrodes being positioned in said measuring-object gas chamber, for detecting the oxygen concentration in said measuring-object gas chamber based on a current value or an electromotive force produced between said monitor electrodes,

8. A multilayered gas sensing element comprising
a measuring-object gas chamber into which a measuring-object gas is introduced under a predetermined diffusion resistance;
an oxygen pump cell having a pair of pump electrodes provided on surfaces of an oxygen ion conductive solid electrolytic substrate, with one of said pump electrodes being positioned in said measuring-object gas chamber, for pumping oxygen into or from said measuring-object gas chamber in response to electric power supplied to said pump electrodes to adjust an oxygen concentration in said measuring-object gas chamber; and
a sensor cell having a pair of sensor electrodes provided on surfaces of an oxygen ion conductive solid electrolytic substrate, with one of said sensor electrodes being positioned in said measuring-object gas chamber, for detecting a specific gas concentration in said measuring-object gas chamber based on an oxygen ion current produced between said sensor electrodes,
wherein said one of the pump electrodes of the oxygen pump cell positioned in said measuring-object gas chamber has a downstream portion positioned at a downstream side of a measuring-object gas introducing hole in a flow direction of said measuring-object gas, and said downstream portion of said one of the pump electrodes satisfies the following relationship
Sg/Se≦0.3
where Se represents an area of the downstream portion of the pump electrode, and Sg represents a total area of a clearance region residing between a side surface of said downstream portion of the pump electrode extending in a longitudinal direction of said gas sensing element and an inside surface of said measuring-object gas chamber.

9. The multilayered gas sensing element in accordance with claim 8, further comprising an oxygen monitor cell having a pair of monitor electrodes provided on surfaces of an oxygen ion conductive solid electrolytic substrate, with one of said monitor electrodes being positioned in said measuring-object gas chamber, for detecting the oxygen concentration in said measuring-object gas chamber based on a current value or an electromotive force produced between said monitor electrodes,

10. A gas sensing element comprising
a plurality of electrochemical cells, each including a solid electrolytic substrate and a pair of electrodes provided on said solid electrolytic substrate;
a measuring-object gas chamber into which a measuring-object gas is introduced;
a spacer laminated on said solid electrolytic substrate for defining said measuring-object gas chamber, and
a gas introducing passage for introducing said measuring-object gas into said measuring-object gas chamber from an outside,
wherein at least one of said plurality of electrochemical cells is a pump cell for pumping oxygen from said measuring-object gas chamber to adjust an oxygen concentration in said measuring-object gas chamber,
at least one of said plurality of electrochemical cells is a sensor cell for decomposing a specific gas in said measuring-object gas chamber to measure a specific gas concentration in said measuring-object gas chamber based on oxygen ions resulting from decomposition of said specific gas,
said measuring gas chamber includes a plurality of cell chambers in which said electrochemical cells are provided, and a rate-determining diffusion passage connecting said cell chambers and allowing said measuring-object gas to flow between said cell chambers with a reduced flow rate, and
said gas introducing passage and said rate-determining diffusion passage satisfy the following relationship
(Sn/Ln)/(S0/L0)≦0.4
where L0 represents a longitudinal length of said gas introducing passage, S0 represents a transverse cross-sectional area of said gas introducing passage, Ln represents a longitudinal length of said rate-determining diffusion passage, and Sn represents a transverse cross-sectional area of said rate-determining diffusion passage.

11. The gas sensing element in accordance with claim 10, wherein a transverse width Wn of said rate-determining diffusion passage is not greater than 0.8 mm.

12. The gas sensing element in accordance with claim 10, wherein the longitudinal length Ln of said rate-determining diffusion passage is not less than 0.4 mm.

13. The gas sensing element in accordance with claim 10, wherein said pump cell is disposed in the cell chamber closest to said gas introducing passage and said sensor cell is disposed in the cell chamber farthest from said gas introducing passage, and said plurality of cell chambers satisfy
v/V≦0.5
where v represents a volume of said sensor cell chamber and V represents a total volume of said plurality of cell chambers.

14. The gas sensing element in accordance with claim 10, wherein a thickness t of the cell chamber taken along a lamination direction of said gas sensing element is not greater than 0.16 mm.

15. The gas sensing element in accordance with claim 10, wherein the total volume of said plurality of cell chambers is not greater than 4.1 mm³.

16. The gas sensing element in accordance with claim 10, wherein a porous member is disposed partly in at least one of said gas introducing passage, said cell chambers, and said rate-determining diffusion passage.

17. The gas sensing element in accordance with claim 16, wherein a porosity of said porous member is 10% to 50%.

18. The gas sensing element in accordance with claim 10, wherein the pump electrode positioned in the pump cell chamber has a region whose surface temperature increases up to 800° C. when said gas sensing element is operating.

19. A gas sensing element comprising
a plurality of electrochemical cells, each including a solid electrolytic substrate and a pair of electrodes provided on said solid electrolytic substrate;
a measuring-object gas chamber into which a measuring-object gas is introduced;
a spacer laminated on said solid electrolytic substrate for defining said measuring-object gas chamber, and
a gas introducing passage for introducing said measuring-object gas into said measuring-object gas chamber from an outside,
wherein at least one of said plurality of electrochemical cells is a pump cell for pumping oxygen from said measuring-object gas chamber to adjust an oxygen concentration in said measuring-object gas chamber,
at least one of said plurality of electrochemical cells is a sensor cell for decomposing a specific gas in said measuring-object gas chamber to measure a specific gas concentration in said measuring-object gas chamber based on oxygen ions resulting from decomposition of said specific gas,
said measuring gas chamber includes a plurality of cell chambers in which said electrochemical cells are provided, and a rate-determining diffusion passage connecting said cell chambers and allowing said measuring-object gas to flow between said cell chambers with a reduced flow rate, and
said pump cell and said sensor cell satisfy the following relationship when the oxygen concentration is 20%,
Is/Ip≦0.3
where Ip represents a pump limit current value flowing between the electrodes of said pump cell, and Is represents a sensor limit current value flowing between the electrodes of said sensor cell under a condition that said pump cell is not operating.

20. The gas sensing element in accordance with claim 19, wherein a transverse width Wn of said rate-determining diffusion passage is not greater than 0.8 mm.

21. The gas sensing element in accordance with claim 19, wherein the longitudinal length Ln of said rate-determining diffusion passage is not less than 0.4 mm.

22. The gas sensing element in accordance with claim 19, wherein said pump cell is disposed in the cell chamber closest to said gas introducing passage and said sensor cell is disposed in the cell chamber farthest from said gas introducing passage, and said plurality of cell chambers satisfy
v/V≦0.5
where v represents a volume of said sensor cell chamber and V represents a total volume of said plurality of cell chambers.

23. The gas sensing element in accordance with claim 19, wherein a thickness t of the cell chamber taken along a lamination direction of said gas sensing element is not greater than 0.16 mm.

24. The gas sensing element in accordance with claim 19, wherein the total volume of said plurality of cell chambers is not greater than 4.1 mm³.

25. The gas sensing element in accordance with claim 19, wherein a porous member is disposed partly in at least one of said gas introducing passage, said cell chambers, and said rate-determining diffusion passage.

26. The gas sensing element in accordance with claim 25, wherein a porosity of said porous member is 10% to 50%.

27. The gas sensing element in accordance with claim 19, wherein the pump electrode positioned in the pump cell chamber has a region whose surface temperature increases up to 800° C. when said gas sensing element is operating.

28. A gas sensing element comprising
a plurality of electrochemical cells, each including a solid electrolytic substrate and a pair of electrodes provided on said solid electrolytic substrate;
a measuring-object gas chamber into which a measuring-object gas is introduced;
a spacer laminated on said solid electrolytic substrate for defining said measuring-object gas chamber, and
a gas introducing passage for introducing said measuring-object gas into said measuring-object gas chamber from an outside,
wherein at least one of said plurality of electrochemical cells is a pump cell for pumping oxygen from said measuring-object gas chamber to adjust an oxygen concentration in said measuring-object gas chamber,
at least one of said plurality of electrochemical cells is a sensor cell for decomposing a specific gas in said measuring-object gas chamber to measure a specific gas concentration in said measuring-object gas chamber based on oxygen ions resulting from decomposition of said specific gas,
said measuring gas chamber includes a plurality of cell chambers in which said electrochemical cells are provided, and a rate-determining diffusion passage connecting said cell chambers and allowing said measuring-object gas to flow between said cell chambers with a reduced flow rate, and
said pump cell and said sensor cell satisfy the following relationship when the oxygen concentration is 20%,
Is/Sp≦0.06 mA/mm²
where Is represents a sensor limit current value flowing between the electrodes of said sensor cell under a condition that said pump cell is not operating, and Sp represents an area of the pump cell electrode positioned in said measuring-object gas chamber.

29. The gas sensing element in accordance with claim 28, wherein a transverse width Wn of said rate-determining diffusion passage is not greater than 0.8 mm.

30. The gas sensing element in accordance with claim 28, wherein the longitudinal length Ln of said rate-determining diffusion passage is not less than 0.4 mm.

31. The gas sensing element in accordance with claim 28, wherein said pump cell is disposed in the cell chamber closest to said gas introducing passage and said sensor cell is disposed in the cell chamber farthest from said gas introducing passage, and said plurality of cell chambers satisfy
v/V≦0.5
where v represents a volume of said sensor cell chamber and V represents a total volume of said plurality of cell chambers.

32. The gas sensing element in accordance with claim 28, wherein a thickness t of the cell chamber taken along a lamination direction of said gas sensing element is not greater than 0.16 mm.

33. The gas sensing element in accordance with claim 28, wherein the total volume of said plurality of cell chambers is not greater than 4.1 mm³.

34. The gas sensing element in accordance with claim 28, wherein a porous member is disposed partly in at least one of said gas introducing passage, said cell chambers, and said rate-determining diffusion passage.

35. The gas sensing element in accordance with claim 34, wherein a porosity of said porous member is 10% to 50%.

36. The gas sensing element in accordance with claim 28, wherein the pump electrode positioned in the pump cell chamber has a region whose surface temperature increases up to 800° C. when said gas sensing element is operating.
